(19) United States
(12) Patent Application Publication
(10) Pub. No.: US 2026/0336098 A1
(43) Pub. Date: Oct. 29, 2026

(54) ROBOTIC SYSTEM AND METHOD FOR PROGRAMING PHYSICAL ROBOT

(71) Applicant: MANTIS ROBOTICS, INC, Pleasanton, CA (US)

(72) Inventors: Pei-Jui Wang, Pleasanton, CA (US); Hung-Sheng Lin, Pleasanton, CA (US); Shou-Min Wang, Pleasanton, CA (US)

(73) Assignee: MANTIS ROBOTICS, INC, Pleasanton, CA (US)

(21) Appl. No.: 19/570,211

(22) Filed: Mar. 18, 2026

Related U.S. Application Data
(60) Provisional application No. 63/773,977, filed on Mar. 18, 2025.

(51) Int. Cl. B25J 9/16

(52) U.S. Cl. CPC B25J 9/1605; B25J 9/1664; B25J 9/1687

(57) ABSTRACT

A robotic system and a method to program a physical robot are provided including establishing one or more virtual objects at least including one or more virtual workpieces, describing the desired process for the one or more virtual workpieces to establish a process flow, assigning the one or more virtual objects to the process flow, and generating robot program according to the process flow, one or more process parameters, and the one or more configurable specifications of the one or more virtual objects. Multiple embodiments are introduced for the implementation of the robotic system and the method to program a physical robot.

### CROSS-REFERENCE TO RELATED APPLICATION

This non-provisional application claims priority under 35 U.S.C. § 119(e) on U.S. provisional Patent Application No(s). 63/773,977 filed on Mar. 18, 2025, the entire contents of which are hereby incorporated by reference.

### BACKGROUND OF THE INVENTION

### 1. Field of the Invention

This disclosure relates to robotic systems and, more particularly, to systems and methods of programming robotic systems.

### 2. Description of the Related Art

When building automation systems, especially those including a robot, the total cost not only includes the cost brought by the equipment and manufacturing but also includes the cost of engineering hours spent on the planning, design and final programming phases of the automation system, which is usually the most expensive one.

The work in the planning phase usually requires co-work between different professionals, for example, electrical engineers, mechanical engineers, automation engineers, and robotics engineers. They need to exchange their professional knowledge at a detailed level to produce a workable plan which transforms the desired automation process to individual requirements of the automation cell components. The feasibility of the work results in the planning and design phase not only affects the iterations and engineering hours in the implementations, but also the cost brought by possible reworks. Professionals need to collaborate with iterations back-and-forth between each other to ensure the relating issues are resolved. At the same time, those iterations also come with much cost of engineering hours, especially when a programable equipment like a multi-axis robot is concerned.

The following disclosure includes technically advanced methods and systems for programming a robot in automation cells or lines.

### BRIEF SUMMARY OF THE INVENTION

The following summary includes certain non-limiting examples of the techniques described herein. In some embodiments, the present disclosure includes a robotic system that includes, for example, a physical robot having a movable part which is configured to couple with the one or more physical tools to process one or more physical workpieces; a controller including a control module (e.g., one or more processors) to control the motion of the physical robot according to a robotic program; and a user interface. The user interface includes one or more configuration interfaces to set one or more virtual objects which at least includes one or more virtual workpieces and to set an initial positional relationship between at least one of the one or more virtual objects and a virtual robot which corresponds to the physical robot, wherein the one or more virtual objects include one or more configurable specifications; and a process flow interface to configure one or more processes for the one or more virtual workpieces including one or more process flow units which display an icon and/or text for one or more users to set the one or more processes with one or more process parameters and are connectable to each other to form at least one process flow, wherein at least one of the one or more process parameters set the change of the relative position between the one or more virtual workpieces and at least one chosen from the one or more virtual objects and/or one or more virtual tools. The robotic system may further include a program generating module (e.g., one or more processors) that generates a robot program and/or a virtual agent according to the at least one process flow, the one or more process parameters and the one or more configurable specifications of the one or more virtual objects.

In some embodiments, the present disclosure includes a method for programming a physical robot including, for example, setting one or more virtual objects at least includes one or more virtual workpieces, wherein the one or more virtual objects include one or more configurable specification and a coordinate; setting one or more initial position of the one or more virtual workpieces; setting an initial positional relationship between the one or more virtual objects and a virtual robot which corresponds to the physical robot; setting one or more process for the one or more virtual workpieces including one or more process parameters to set the change of the relative position between the one or more virtual workpieces and at least one chosen from the one or more virtual objects, the virtual robot, a world coordinate, and/or one or more virtual tools, wherein one or more process for the one or more virtual workpieces are set according to a sequential relationship of the desired process of the one or more virtual workpieces; and generating a robotic program according to the one or more processes, the one or more process parameters and the one or more configurable specifications of the one or more virtual workpieces.

Multiple additional embodiments and examples are disclosed, including examples of visualizing a process flow, through a graphical method or a text-based method, examples of configuring virtual objects, examples of coupling virtual objects to the process flow, examples of simulation of the process flow with assigned workforce include a robot or a human worker, and examples of generating new workpieces by combining existing workpieces. Examples of the programming method in different kinds of application are also disclosed, including examples of a pick and place application with stack of trays, examples of an inspection application, and examples of an assembly application.

### BRIEF DESCRIPTION OF THE DRAWINGS

FIG. 1 is a diagram of examples of conventional robotic programming methods.

FIG. 2 is a side view of an illustrative robotic cell of a pick and place and inspection application.

FIG. 3 is an illustrative user interface for programming a workpiece-based process flow in accordance with some embodiments.

FIG. 4 is an illustrative robotic system including a user interface in accordance with some embodiments.

FIG. 5 is an illustrative user interface of the workpiece-based process flow of an inspection application in accordance with some embodiments.

FIG. 6 is an illustrative user interface for configuring a virtual object in accordance with some embodiments.

FIG. 7 is an illustrative user interface of a virtual inspection application cell in accordance with some embodiments.

FIG. 8 is an illustrative user interface of a virtual inspection application cell which is assigned with a robotic workforce in accordance with some embodiments.

FIG. 9 is an illustrative user interface of a workpiece-based process flow of a labeling application and assigned with robotic workforce and human workforce in accordance with some embodiments.

FIG. 10 is an illustrative user interface of a workpiece-based process flow of an assembly application in accordance with some embodiments.

FIG. 11 is an illustrative user interface for configuring an assembly application in accordance with some embodiments.

FIG. 12 is a diagram of an illustrative three-dimensional workpiece-based process flow in accordance with some embodiments.

FIG. 13 is a diagram of different kinds of illustrative workpiece-based process flows that use text-based visualization in accordance with some embodiments.

FIG. 14 is a diagram of examples of the program codes in accordance with some embodiments.

FIG. 15 is a diagram of an example of software architecture in accordance with some embodiments.

### DETAILED DESCRIPTION OF THE INVENTION

The following description provides a variety of examples and specific details for a thorough illustration and understanding of the disclosed embodiments. One of ordinary skill in the art will understand that one or more examples, embodiments, and various details may be practiced without one or more other specific details. In some instances, specific description of well-known structures or functions may have been omitted to avoid unnecessarily obscuring the description of the embodiments.

Compared with programable equipment without a physical movable body, for example, a PLC (Programable Logic Controller), which can be easily defined and planned with logics, programable equipment with a physical movable body, especially those with complicated three-dimensional kinematical movements, for example, a six-axis articulated robot, are harder to design-in to an automation system. Reachability and singularity are usually the initial difficulties in integrating a robot into an automation cell. Many constraints come from the desired process to the workpiece, e.g., desired motion and desired orientation of the workpiece.

To reduce the cost of reworks, the conventional way is to simulate the robot's motion with a full program code of a robot and designed physical environments. But this is usually not applicable, because in the planning and design phase, many conditions that are required in a simulation which may be not yet fixed, e.g., mechanical designs of the jigs, or the placement of equipment. In contrast, sometimes these missing conditions are usually pending for a conclusion of the simulation of robot's motion to start with. Mechanical engineers are usually waiting the robotics engineers to give constrains for the mechanical design, but at the same time the robotics engineer may be also waiting for the mechanical engineer to produce a ready-to-simulate CAD (Computer-aided design) file for the simulation, so automation engineers are usually needed. They need to handle the desired automation target and deal with the cooperation between other engineers. However, automation engineers usually lack a suitable tool to create a feasible concept, and they rely on the professional skills of mechanical engineers and robotics engineers on CAD software, robotic programming software and/or robotic simulation software. In such a case, a feasible design usually can only be achieved through a step-by-step process with multiple iterations between multiple professionals—which may mean multiple revisions of mechanical design and robotic programming.

However, the simulation of a robot still requires an effort no less than programming a real robot, because most of the robotic simulator only simulates the controller of the robotic products, while the programming of the industrial robots nowadays still requires effort for users to make a full instruction with desired motion and actions of the robot in detail to achieve the automation, instead of instructing what is the desired automation process or how the workpieces should be processed. In some cases, a robotic simulation can take more effort than programming a real robot because other than programing the robot in the simulator, engineers also need to program all objects other than the robot to achieve the final simulation. The effort may then be further multiplied by the iterations with the mechanical engineers, as described previously.

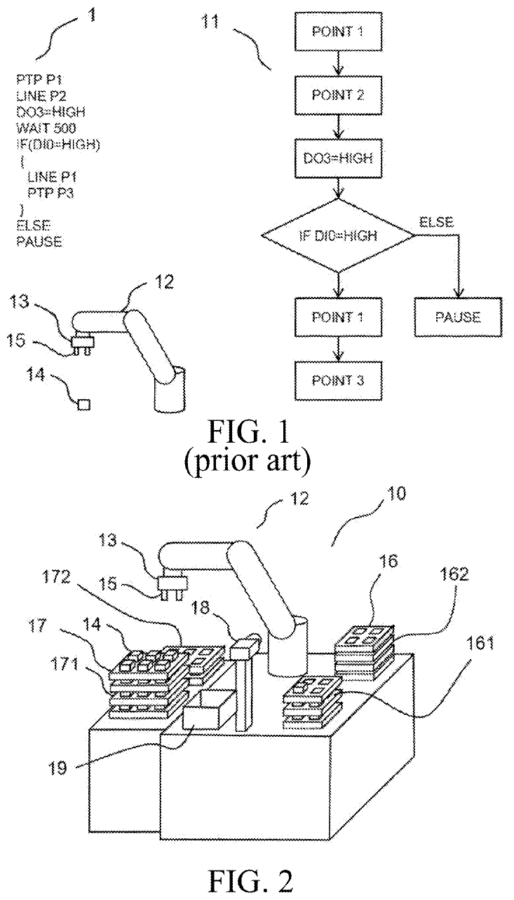

Refer to FIG. 1 for some examples of robotic programming nowadays. Most of industrial robots need to be programed with machine code (sometimes referred to herein as robot code, robotic program, programming language, or robot language), for example, machine code 1 (sometimes referred to herein as robot-code-based programming), which described the motion that robot should perform, e.g., a point-to-point joint based motion (e.g., “PTP”) to a pose P1, the action like pull high a specific digital output port in the robot's control box (e.g., “DO3=HIGH”), and the logical judgment and decision (e.g., “IF-ELSE”). The example of machine code 1 shows what the user may need to program to instruct a robot 12 to perform the actions to pick up a workpiece 14 with a gripper 13 (sometimes referred to herein as a tool, an end-effector, an end-of-the-arm-tool, or an EOAT) which include: move to a pose P1 configured by the user with a point-to-point motion (PTP) which is usually a pose right above the workpiece 14 (e.g., P1, or a lead-in point); move to P2 configured by the user to put gripper 13 to a pre-gripping pose (e.g., P2) to workpiece 14 using a linear motion (LINE), so fingers 15 of gripper 13 will not collide with workpiece 14; close fingers 15 through pulling a specific digital output (e.g., digital output No. 3) coupled with gripper 13 to logic high (DO3=HIGH) to grip workpiece 14; waiting for 500 milliseconds (WAIT 500) for the motion of fingers 15; check the feedback of gripper 13 from a digital input port of the robot's control box coupled to gripper 13, e.g., IF(DI0=HIGH), to check if fingers 15 are successfully closed and workpiece 14 are successfully grasped (e.g., with a predefined gripping force and/or it's not an empty-gripping); and then, moving workpiece 14 straight upward (to a lead-out point, usually the same with the lead-in point, e.g., LINE P1) and move it with a point-to-point motion to a desired pose e.g., P3. If gripper 13 didn't successfully gripped workpiece 14, robot 12 is paused (ELSE, PAUSE) for the human worker to check.

According to the example of machine code 1, the users need to remember those machine codes and type them correctly to program the robot. Recently some other approaches of robotic programming are provided which uses a graphical interface with predefined icons representing different types of machine codes with which users can drag-and-drop and connect them to construct a machine code flow 11 (sometimes referred to herein as flow-based robot code programming) to program the robot. More detailed assignments, e.g., the motion types, may be shown in some sub-icons adjacent to the icons or a one-level deeper graphical interface popping up after clicking the icons. In such a programming method, users still need to program the machine code of the robot. Furthermore, when the program is more complicated, it will take up more space in the GUI (Graphical User Interface) to contain a full graphical representation of the machine code than the text-type machine code and may bring difficulties for users to understand the overall robotic program.

The example shown in FIG. 1 presented the effort to program a basic action of a robot to pick a workpiece. In a real application, there are usually more program lines or icons that need to be programed. For example, if the automation process involves trays that carrying multiple workpieces, and there are multiple trays stacked to each other. For example, a tray may have three-by-two slots for carrying workpieces, and there may be ten layers of trays in a stack (sometimes referred to herein as a stack of trays or a tray stack). There may be six hundred points to reach, for example, and if including the lead-in or lead-out points (e.g., P1 in FIG. 1), it will be equal to or more than doubled. Of course, some machine code has relative motion commands (e.g., moving 3 millimeters along X or Y axis) and users may not need to teach six hundred points, but that also raises the issue of needing to program a more advanced machine code including mathematical formulas and variables.

The points like the P1, P2, and P3 shown in FIG. 1 are usually defined with a cartesian coordinate like X, Y, Z (positions) and RX, RY, RZ (orientations), or a joint space coordinate. For example, a joint space coordinate definition may specify that the first joint (e.g., J1) should move to 30 degrees, J2 should move to 25 degrees, etc. Those positions usually need be manually defined, assigned, or taught (e.g., by “jogging” the robot, which is to control the robot incrementally to a desired pose to align a physical object and record the pose), which may cost plenty of engineering hours.

In some cases, for a workpiece handling application with tray stacks, during the design phase, robotics engineers may need to check the CAD file provided by the mechanical engineers to fully understand the structure of the tray, like how the trays stack together (e.g., if there is a mechanical feature for stacking and how deep is the insertion between them), how deep the slots are sunk for mounting the workpiece, and the dimensions of the workpieces. Then they may need to calculate them manually to get the coordinates for correct machine code programming. However, if the mechanical design changes (e.g., because constraints are violated), all the effort may need to be made again.

Overall, in the existing methods to program a robot to perform an automation task, the users need to transform the desired process of the automation to the desired poses, motions, and actions of the robot. This may involve many mathematical models of the physical object and environment, requiring professional skill of robotics, in multiple iterations in the planning and design phase. Meanwhile, mechanical engineers may need to spend the same amount of effort for the same purpose, which brings a high engineering time or cost. Therefore, it may be advantageous to provide an improved method to program a robot in an automation system to reduce the cost of the engineering hours in the planning and design phase and final program implementation of the robot. Or, to provide a robotic system that has a better ability to understand more from the desired automation process instead of a desired motion and is capable of being instructed via the desired automation process rather than machine codes.

FIG. 2 is a diagram of an illustrative work cell 10 (sometimes referred to herein as a production system, an automation system, an automation cell, a processing station, a production station, or a production cell). Work cell 10 is one illustrative example of a processing station in a production line. The objective of a process performed at work cell 10 is to bring workpiece 14 (sometimes referred to herein as a processing target) to one or more positions in front of an inspection camera 18 (sometimes referred to herein as an inspection sensor or an application sensor) to inspect if workpiece 14 has a defect. In various example embodiments, work cell 10 may be coupled with one or more previous work cells (not shown), for manufacturing of workpiece 14, and one or more post work cells (not shown), for packaging workpiece 14. One may choose to use a tray to deliver multiple workpieces 14 between these work cells for processing, such as arrayed tray 16 and 17, for example. Those trays may be able to stack between each other to enlarge the capacity, like tray stack 161, 162, 171 and 172. Tray stack 161 (sometimes referred to herein as an input tray stack or a source tray stack), which carries multiple pre-processed workpieces 14, may be the input of work cell 10, and tray stack 171 (sometimes referred to herein as an output tray stack or a destination tray stack) may be the output. While pre-processed workpieces are all taken from one layer of tray 16, the emptied tray 16 may need to be removed from the top of the tray stack 161 and be stacked aside, for example, staked in the empty tray stack 162. After workpiece 14 is inspected by camera 18, the desired process may be to place those workpieces 14 that passed (sometimes referred herein as “OK”) the inspection to tray stack 171, and place any that do not pass (sometimes referred herein as “Not Good” or “NG”) into a container 19 (sometimes referred to herein as an NG box). When a layer of tray 17 is filled with processed workpieces 14, an empty tray may be taken from an empty tray stack 172 (sometimes referred to herein as refilling trays) and be stacked onto the top of tray stack 171 to carry the coming processed workpiece 14. In this example, from time to time, the input tray stack 161 and refilling trays 172 should be supplied, and output tray stack 171 and emptied tray 162 should be removed, to continue the process.

The processes in work cell 10 may be performed by different kinds of workforces, for example, a human worker or a robot 12 with a robot arm 120 (sometimes referred to herein as a manipulator). In the case of a human worker as the workforce, the instruction for a human worker is straight forward. For example, “Workpiece 14 should be posed (to a certain relative pose to an object) five centimeters in front of the camera 18. If the result shows OK, place it to tray stack 171. If the result shows NG, put it to NG box 19.”. When robot 12 is chosen to perform as the workforce of the same application through existing methods of robotic programming, it may take much more effort to make it work.

First, robot 12 may not be able to reach each desired pose of the process. There might be fifty to more than one hundred poses in work cell 10 while most of them are the griping pose and pre-gripping poses for workpiece 14 in each slot of the trays and in each layer of a tray stack. Further, a typical existing robot 12 may not understand such concepts as: how many slots are in each tray, what are the distances (e.g., in directions of width and length) between each slot, when will a tray be filled or emptied, and how to handle an empty tray. All these steps to be mathematically modeled by robotics engineers with many variables, formulas, and machine codes. When the input and output trays have different shapes, sizes, and/or amounts of slots, like the example shown in work cell 10, it is especially difficult to ensure everything is correctly coded or programmed.

Furthermore, the situation after adding a tool 13 to the robot may be totally different. In the planning and design phase, the end-of-the-arm-tool or EOAT is usually not defined yet and information about finger 15 may not even exist. Thus, many difficulties come from additional uncertainties relating to tool 13, and many professional engineering hours may need to be spent to transform the desired processes of production into a desired robotic automation result using existing techniques.

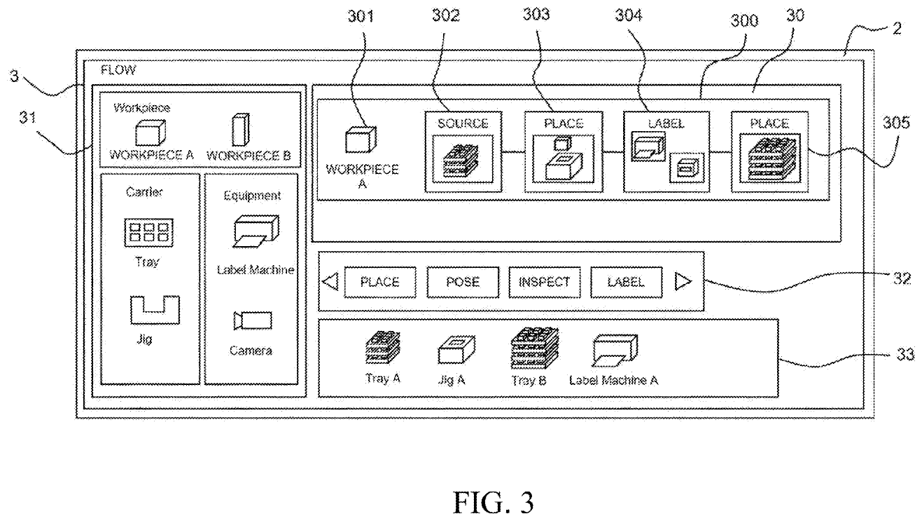

FIG. 3 is an illustrative user interface which may be included in a robotic system according to an embodiment. In some embodiments, users may program more from a point of view of a desired process of production or manufacturing than from a point of view of desired machinery actions, through operating the user interface 2 (sometimes referred to herein as graphical user interface or GUI).

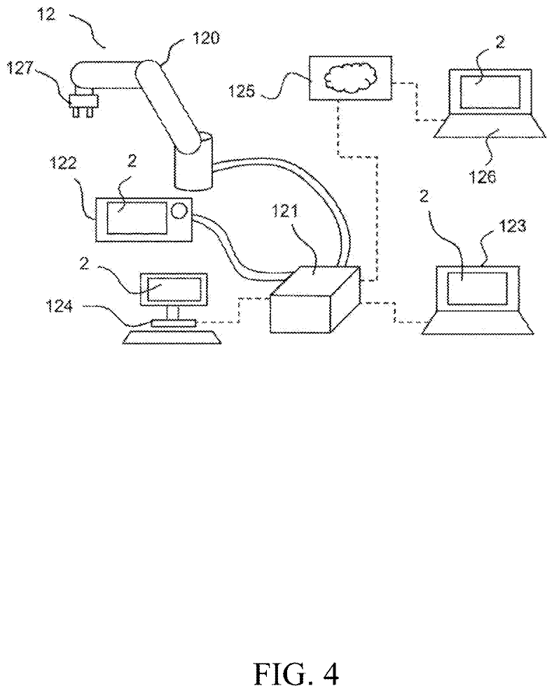

FIG. 4 shows an illustrative robotic system. Robot 12 may include a robot arm 120 and a controller 121 (sometimes referred to herein as a control box). Robot arm 120 may include multiple movable parts driven by actuators, for example. Controller 121 may include a storage device (not shown) for storing processing instructions such as machine codes and one or more processors (not shown) which may control the motion, action, or operation of robot 12 by running or executing the machine code stored in the storage device. Example storage devices may include storage circuitry, non-volatile memory, volatile memory, one or more hard drives, solid state drives, read-only memory, flash memory, etc.). Example processors may include central processing units (CPUs), graphics processing units (GPUs), integrated circuits (ICs), application specific integrated circuits (ASICs), microprocessors, etc.

User interface 2 may be provided for users to program or generate the desired automation processes, and robot's motions, operations and actions. In various embodiments, user interface 2 may execute on a device coupled to controller 121 directly (e.g., electronic device 122), over a local network (e.g., computers 123-124), or over a wide area network 125 (e.g., computer 126). User interface 2 may have multiple parts, including a calculation part and a visualization part, which may execute on the same or different processor(s). For example, both the calculation part and the visualization part may be set in controller 121 as a part of robot 12, and users can access user interface 2 through an electronic device (e.g., a computer) having display and input functions. In other embodiments, the calculation part may be executed in the controller 121, for example, and the controller 121 may work with another electronic device loaded with the visualization part of user interface 2.

For example, user interface 2 may be included in robot 12, executing on one or more processors in controller 121 and user can access the user interface 2 through connecting a display and input equipment 124 (e.g., a monitor, a keyboard, a mouse, or a touchscreen) to controller 121. Robot 12 may include a teach pendant 122 (sometimes referred herein as a pendent or a teach box) connecting to controller 121 with a cable or wireless communication. Teach pendant 122 may be a passive type teach pendant including display and input functions (e.g., a monitor with a touch screen to display the visualized result of the user interface 2 and receive user's input by touching the screen).

In other examples, user interface 2 may be provided to users on a computer 123 (e.g., desktop computer, notebooks, or tablet) or a teach pendant 122 and the calculation part of user interface 2 may be executed on the controller 121, computer 123, or teach pendant 122 (e.g., an active type teach pendant executing software). For example, via utilizing web-based technology, the visualization part of the user interface 2 may be a client (e.g., a web browser) executed on computer 123 or pendant 122, and a web server executed on controller 121 implements the calculation part of the user interface 2. Alternatively, in a client-server structure, a computer 123 or pendant 122 may execute a client program and communicate with a server program executed on controller 121, for example.

If desired, both the calculation part and the visualization part of user interface 2 may be executed on computer 123 or pendant 122, while the communication to controller 121 may be a lower-level data transmission, such as machine code, for example. In this case, the one or more processors in controller 121 may be a lighter or simpler type, but the computer 123 or pendant 122 may be required to have a higher performance.

Sometimes video streaming may also work to display user interface 2 (that executes in controller 121) on computer 123 or pendant 122, although computer 123 and pendant 122 are active devices. In this case, the visualization is first done in controller 121 and then transformed into a streaming video data or signal to the active devices, and visualized on them, which may reduce the performance requirements of the remote active devices.

User interface 2 may be provided to program and control a physical robot 12. But in many cases, having a robot 12, or choosing different kinds (e.g., different structures, number of axes, reaches and payloads) of robot, may be decided in the planning and design phase of work, so a simulated robot (sometimes referred to herein as a virtual robot which corresponds to the physical robot 12) is usually provided for users to program and manipulate in a simulated space of work cell, which is commonly called an offline simulation. In such cases, user interface 2 may be used to program a simulated robot. A simulated robot may include a simulated controller which may compile the machine code of robot 12 and simulate the action of robot arm 120, EOAT 127, and controller 121. A simulated robot may be executed on a computer (e.g., computer 123) that runs user interface 2 without connecting to a physical robot 12 for users to perform an offline simulation. When users are satisfied with the simulation, the machine code may be put to a physical controller 121 through a communication mechanism (e.g., network) or through a storage device inserted to controller 121, for example. A simulated robot may also be put to an active type of teach pendant 122, computer 123, or controller 121. User interface 2 may connect to both a physical robot 12 and a simulated robot at the same time and may provide a function to allow users to switch between controlling or programming a simulated robot and a physical robot, and synchronize or stop synchronizing their status (e.g., pose, digital outputs, programming, or execution of programming) when desired. For example, users may program or control a simulated robot with user interface 2 without moving physical robot 12, which is useful when users want to perform trial teaching, trial programming, or trial running on the simulated robot to have a verification (e.g., if the robot will collide with an object in the environment) before moving the physical robot.

Furthermore, user interface 2 may be executed on one or more processors used to form one or more cloud servers (e.g., cloud server 125) and users may access user interface 2 through a network to a cloud environment with a computer 126, for example. Cloud server 125 may include a simulated robot and/or a simulated work cell.

According to these examples, there are multiple ways to execute user interface 2 to one or more processors in the robotic system or robotic automation system, including being part of robot 12 or not, online or offline, and with a physical robot or a simulated robot, which should not become a limitation of the disclosed programming method.

FIG. 3 illustrates an example technique to transform a desired production process of automation to a desired pose, motion, and actions of the robot. User interface 2 may be provided with a process flow interface 3 (sometimes referred to herein as a production flow, a production process, a process flow, or “FLOW” page) for a user to assign the desired production process. Process flow interface 3 may include a process flow canvas 30 (sometimes referred to herein as process flow 30) and a virtual object model list 31. Virtual object model list 31 may include an interface to set up various elements, such as a workpiece in the process flow, for example. A workpiece may be coupled to (aka, associated with or linked to) a workpiece flow island 300 (sometimes referred to herein as a workpiece island, a workpiece life period, or the life period of a workpiece) for assigning the desired process of a workpiece in the automation process. User interface 2 may provide an interface to configure the parameters of a workpiece, like size, shape, weight, material, and/or its coordinate system. If there is more than one workpiece in the automation process, user interface 2 may provide the function for establishing different workpieces, e.g., workpiece A and workpiece B, and each is coupled with different workpiece flow islands. If desired, after a workpiece 301 is configured or created (e.g., workpiece A), a workpiece flow island 300 coupled with the workpiece may be automatically established (e.g., workpiece flow island of workpiece A).

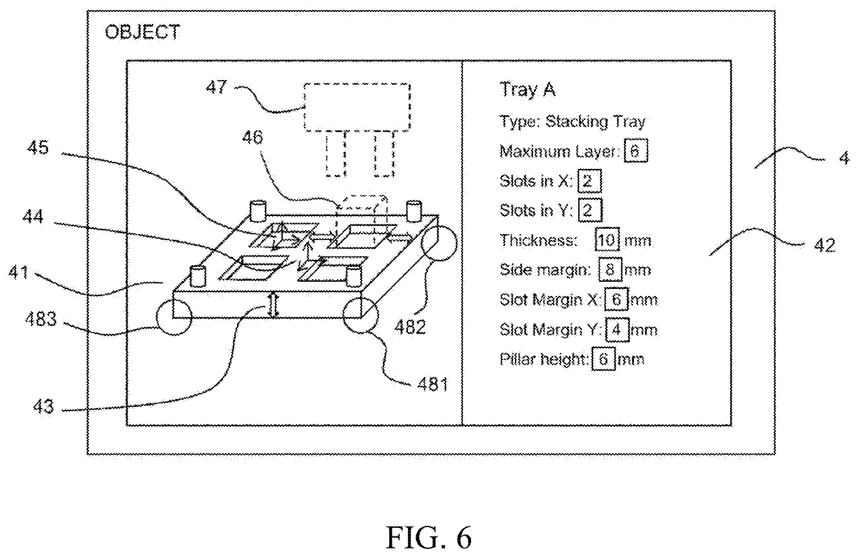

Virtual object model list 31 may include a list of pre-established templates or models of virtual objects, like a tray, a tray stack, a jig, a plate, or a box, which may be categorized as carriers; a label machine, a machine tool, an oven, a stamping press, or sensors like a camera, which may be categorized as equipment. User interface 2 may provide an interface for configuring the parameters of a virtual object like size, shape, geometric features (e.g., slots of a tray), weight, material, and/or its coordinate system. FIG. 6 illustrates an example of a configuration interface of a virtual object and is described further below. In some embodiments, configured or created virtual objects may be displayed in an established virtual object list 33 of FIG. 3 (sometimes referred to herein as a list of established virtual objects).

Process flow interface 3 may include a flow block list 32 (sometimes referred to herein as a process block list or a process list) that describes the possible processes to be applied to the workpiece, for example, place, pose, inspect, and label. In some embodiments, user interface 2 may provide a function for users to drag and drop these flow blocks from flow block list 32 to workpiece flow island 300. After a flow block (e.g., flow block 303, 304, and 305) is established on workpiece flow island 300 which is the workpiece flow island of workpiece A, it may mean “Workpiece A should be placed to . . . ” (e.g., flow block 303 and 305) or “Workpiece A should be labeled” (e.g., flow block 304).

Each flow block may include one or more slots for users to assign the virtual objects the flow block is coupled with. For example, a “PLACE” flow block (e.g., flow block 303 or 305) may include a slot for user to drag and drop an established virtual object for the destination to place workpiece A. For example, Jig A is assigned to flow block 303 and may mean “Workpiece A should be placed to Jig A”. While in flow block 305, Tray B may be assigned and may mean “Workpiece A should be placed to Tray B”. The flow block 304, which is a flow block for labeling, may be assigned with Label Machine A to describe “Workpiece A should be labeled with a label output from Label Machine A”. If desired, the flow block 304 for labeling may further include an interface (e.g., an icon) for users to set where the label should be placed on the workpiece, for example.

In some embodiments, after a user puts a flow block on the workpiece island 300, the user interface 2 may further include instructions to allow a user to click an empty slot on the flow block to establish a new virtual object. For example, pop up a window may be generated with step-by-step instructions for creating a new virtual object, or user interface 2 may highlight the possible categories of virtual objects templates in the virtual object model list 31 (e.g., Carriers are allowable to be assigned as a destination of a “PLACE” flow block). Furthermore, user interface 2 may include some rules for assignable virtual objects on the slots of different flow blocks, or different slots in a flow block. For example, in the assignable virtual object for the slot of the “PLACE” flow block may be limited to “Carrier” type virtual objects, which is defined with specific positions to mount workpieces so other types of virtual objects, e.g., a sensor type of virtual objects like a camera which can't carry a workpiece, will be rejected because it does not match the intention of assigning a carrier to a workpiece. Some protection may be provided based on user-friendly design, like not allowing users to drop non-matching types of virtual objects to specific flow blocks, or when clicking the empty slot on the flow block, only those assignable types of virtual objects are shown, or only making them possible to be dragged, in the virtual object model list 31 and/or established virtual object list 33.

Workpiece flow island 300 may also include a function to set the initial states of the workpiece. An initial state may include where the workpiece comes from or a definition of the inputs of an automation cell, for example. In some embodiments, a “SOURCE” flow block 302 for describing where the Workpiece A comes from may be included in user interface 3. The SOURCE may appear in default when workpiece flow island of Workpiece A is established, as the “head” of the process flow and have a slot on it for the user to assign a virtual object. For example, Tray A is assigned to flow block 302, which may mean “Workpiece A comes from Tray A”. There are other similar mechanisms to set the initial position of the workpiece, such as, for example, clicking the icon of Workpiece A 301 and setting its “source” in a pop-up window. The disclosed example in FIG. 3 is just an example that allows users to see the important descriptions with a glance at workpiece flow island 300.

The flow blocks in workpiece flow island 300 may be arranged in a sequence to define the order of the process. For example, the arrangement of flow blocks 302, 303, 304 and 305 on the workpiece flow island 300 of Workpiece A as shown in FIG. 3 may mean “Workpiece A comes from Tray A, should be placed to Jig A, labeled with a label comes from Label Machine A, and then be placed to Tray B”. Which is like the description that one needs to instruct a human worker.

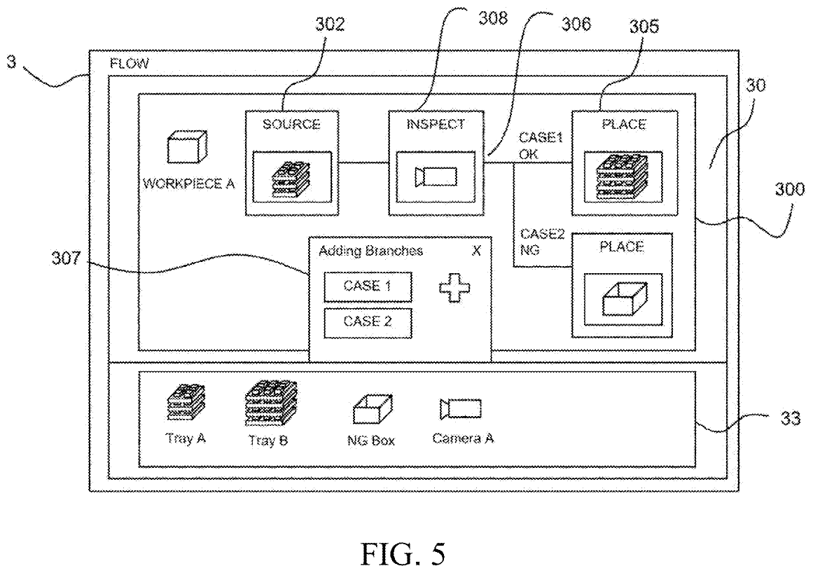

Refer to FIG. 5 for another example of arrangement of flow blocks in workpiece flow island 300, which may describe the process of the automation cell shown in FIG. 2 “Workpiece A comes from Tray A. It should be inspected by Camera A, and then, if OK, it should be placed to Tray B. If NG (not good), it should be placed to NG Box”. As shown in position 306 in the process flow, the flow block 308 may have branches for the following flow block, according to a set criterion, or a logical judgment result in the process inside flow block 308. In one example embodiment, the branches may be added to the process flow by clicking the flow block to pop up a window 307 to set up with logical cases. If desired, the name of the cases of the branches may be shown in the user interface like “Case 1 OK” or “Case 2 NG” nearby the branches, so users can have a quick understanding about the process.

FIG. 6 illustrates an example of virtual object configuration interface 4 (sometimes referred to herein as virtual object setting page, object setting page, cell object setting page, “WORKPIECE” page, or “OBJECT” page) provided by user interface 2 for a user to create desired virtual objects from pre-defined templates. Virtual object configuration interface 4 may provide features to configure a virtual object, like trays, jigs, machines, or workpieces. For example, virtual object configuration interface 4 may include a two-dimensional or a three-dimensional visualization of the virtual object 41, a configuration panel 42 for configuring the parameters of the virtual object 41. The example shown in FIG. 6 is a configuration interface of a virtual object of the “stacking tray” type. When user establishes the virtual object, for example, choosing a virtual object model from virtual object model list 31 in FIG. 3, each virtual object model may be set with a set of default parameters, which may be easier for users to use them directly as a conceptual set up and then make further configuration later. The parameters may include size, shape, weight, material, density, and the coordinate system of the virtual object. The parameters may further include settings of specific types of virtual objects, for example, the maximum layers of the stacking tray and the number of slots of the tray. The parameters may further include the definition of geometric features or specific functional positions on a virtual object. For example, the slots that are intended to contain a workpiece in a tray, the picking point of a workpiece, a position that should be labeled on a workpiece, or an output position of a label of a label machine. For defining a specific functional position, the interface may provide a coordinate icon 45 for defining the translation and the orientation of the specific position, which is useful to define the six-dimensional (e.g., X, Y, Z, RX, RY, RZ) relationship between the specific position or geometrical feature and its functional counterparts (e.g., the picking point of a workpiece and the finger of the gripper, or the slot of a tray and the workpiece). If desired, a visualization of a workpiece 46 and a gripper 47 may be provided in the same interface, for users to check more details. For example, provide an animation of gripper 47 picking or placing workpiece 46 in one or more tray slots, to check if the fingers of the gripper 47 will collide with nearby workpieces, the pillars of the tray, or the tray itself. Furthermore, during the animation or simulation, a collision detection function may be provided to reduce the effort of manual checking.

In some embodiments, in addition to attributes such as length, width, and height, the virtual object configuration parameters may further include automation scenario parameters. For example, parameters to set the margin between the slots in a tray may be more straightforward than setting the center-to-center relationship between the slots for preventing the finger of a gripper collide to the nearby workpieces in the next row or column of the tray because the size of the margin may be more directly related to the thickness of the finger. In some embodiments, size related parameters may be adjustable in the visualization of the virtual objects in addition to, or instead of, parameter panel 42. For example, two-dimensional or a three-dimensional graphical interface, for example, may include an adjustable bar or an arrow 43 to change size parameters of the objects. And those size-related parameters may be bi-directionally adjustable and automatically propagate changes between the visualization of the model of the virtual object 41 and the parameter panel 42.

Referring to both FIGS. 5 and 6, the user interface 3 may include a function to automatically set the initial parameters when establishing a virtual workpiece based on the relationship of the assignment of the virtual objects. For example, when assigning a tray type of virtual object to flow block 302 or 305 in FIG. 5, the initial dimension of the slots in the tray may be set according to the size of Workpiece A because the tray is associated with (e.g., intended to carry) Workpiece A and the flow blocks are put in the workpiece flow island 300 which belongs to (aka is associated with) Workpiece A. This kind of auto-fitting, auto-generating, or auto-designing functions may largely reduce the time and effort to generate a first result of the concept of the automation cell. Furthermore, when the size of a virtual object is changed by configuration, the functional feature in the accordance counterpart may automatically update. For example, when users change the size of a workpiece, the size of the slot is automatically updated to the newly configured workpiece size. These features may solve the pain in the back-and-forth adjustment for optimizing the automation concept, which usually needs to rely on iterations between automation engineers and mechanical engineers. Although some of the CAD software may have parameterized geometrical functions, in most cases a mechanical engineer still must put in additional effort to set them correctly and systematically. As a comparison, the disclosed example may provide a better way for automation engineers to quickly establish their first concept, while they can perform the optimization of iterations without working with mechanical engineers, which may shorten the conceptual process of an automation cell from weeks to hours.

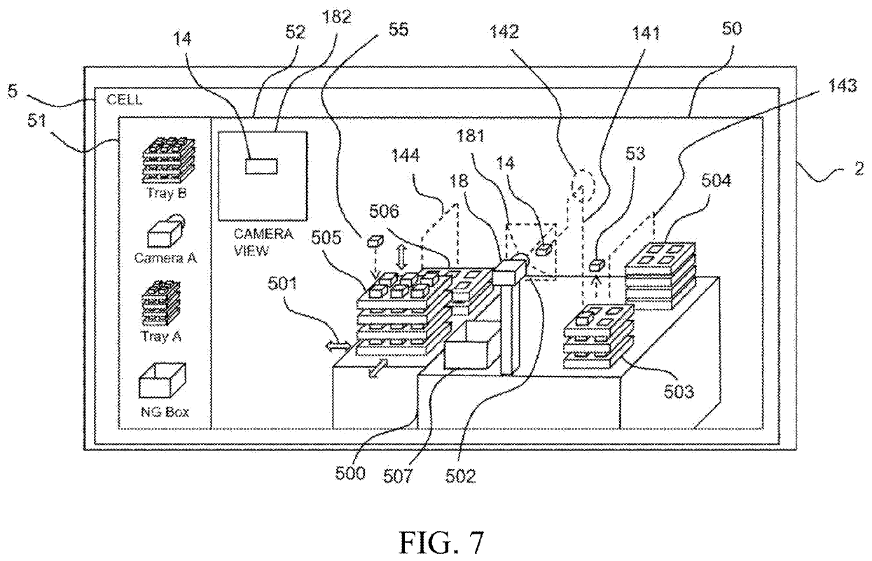

Referring to FIG. 7, the user interface 2 may provide a virtual object position arrangement interface 5 (sometimes referred to herein as virtual object position assignment page, positioning interface of cell object, or “CELL” page) for a user to define the positions of the virtual objects in an automation cell (sometimes referred to herein as cell objects) or the relative position of them in a specific coordinate system. The virtual object position arrangement interface 5 may provide a list of established virtual objects 51 which may be similar to or the same with the established virtual object list 33 in the “FLOW” page in FIG. 5. The list of the established virtual objects 51 may provide a function to drag and drop established virtual objects to a two-dimensional or a three-dimensional visualization of an automation cell or an automation line 50 (sometimes referred to herein as cell space, or cell canvas) and place them in a specific position in the space of the visualized automation cell. Icons like icon 501 for moving virtual objects may be provided to adjust the two-dimensional or three-dimensional position and/or orientation of virtual objects. If desired, virtual objects that are helpful to build a clear visualization of the automation cell/line, like a virtual table 500, may be established in the cell space 50. The virtual objects placed in cell space 50 may be assigned to be included in a world coordinate system, a coordinate system established on static virtual objects like virtual table 500, or a coordinate system of a specific virtual objects which may have a moving function, like a conveyor, a slider, or a turning table (not shown in the figure) for users to manage the positional relationship easily. For example, once users adjust the position of the virtual table 500, the virtual objects on the top of the virtual table 500 should move with it.

If desired, the virtual objects coupled with specific flow blocks may be visualize with animations to help the users to distinguishing their roles, for example, an animation 55 showing a workpiece 14 landing in the tray stack 505 may indicate the tray stack 505 is coupled with a flow block like the “PLACE” block. An animation 53 on the top of tray stack 503 showing a workpiece 14 rising from tray stack 503 may indicate tray stack 503 is assigned as the source of the workpiece.

Referring to both FIG. 5 and FIG. 7, after users defined the process flow of a workpiece in “FLOW” (FIG. 5) and defined the position of the virtual objects in “CELL” (FIG. 7), the user interface 2 shown in FIG. 7 may provide a function to visualize the change of the status of one or more workpiece in timeline according to the process flow. The change in the status of a workpiece may be the change of its position (e.g., a workpiece moves from one position to another), the change of its relationship with other virtual objects, the coupled virtual objects (e.g., a workpiece moves from one tray to another), or the change of its identity according to the process (e.g., a not labeled workpiece is changed to a labeled one, a workpiece that was not yet screwed is changed to a screwed one, or a pre-inspection workpiece is changed to an “OK” workpiece or an “NG” workpiece). If desired, the change of the status of a workpiece can be visualized through animation. For example, in the visualization of cell space 50 in FIG. 7, according to the flow process set in FIG. 5, the visualized workpiece 14 in FIG. 7 may first move from a visualized two-by-two tray 503, which is an input tray, to the front of a visualized inspection camera 502. A dotted line 141 may represent a possible motion trace of workpiece 14, while a dotted circle 142 may present a desired change of the orientation of workpiece 14 to show one or more desired faces of the workpiece for inspection, e.g., a face which the workpiece is labeled. The dotted line 141 and dotted circle 142 may be generated according to a desired relative position orientation set according to the specification of the focal length and/or the field of view of the inspection camera 502 and the desired inspection position or part of the workpiece. Then, according to the result of the inspection, virtual workpiece 14 may move to tray 505 which is the tray to contain the “OK” workpieces, or move to NG Box 507, if the result of the inspection is “NG”. Furthermore, when one layer of the input tray 503 is empty (that all workpieces on it are taken), a layer of tray stack 503 may move to the empty tray stack 504, with a path like dotted line 143 shows. When a layer of tray 505 is full, a layer of try in tray stack 506 may move to the top of tray 505 with a path 144 shown in a dotted line.

Although not shown in the figures, if desired, the positional and orientational relationship between a workpiece and an inspection camera may be set in a setting interface in “INSPECT” flow block 308 in FIG. 5, with a visualization configuration similar to the virtual object 41 and the configuration panel 42 in FIG. 6, or directly in the “CELL” page in FIG. 7. For example, referring to FIG. 7, a visualized inspection camera 18 may be provided with a visualized simulated field of view 181 which may be a virtual pyramid. Users may manipulate a virtual workpiece 14 to a suitable relative position and orientation to the inspection camera 18. Furthermore, the interface may include a simulated image 182 of the view of the inspection camera 18, so users can check in advance if the workpiece is in a proper position in the view of the camera and has a suitable distance to the lens. If desired, the same interface may include a function to simulate the zoom-in or zoom-out of the lens of the inspection camera and a simulated image of the view of the inspection camera for helping users to assign the desired position of the workpiece in front of the camera. In another example, the desired position of a workpiece may be set in the configuration interface of the virtual workpiece, while the user interface may automatically generate inspection position and orientation of the workpiece in front of the inspection camera.

Referring to FIG. 7, the paths 141, 142, 143 and 144 may be automatically generated according to the set positional and/or orientational relationship to the relationship of coupled virtual objects, e.g., the position of the slots in a tray for a workpiece, the depth of the slots (may related to how is linear motion of the workpiece should perform to leave a slot), stacking of trays, the order of the workpieces on a tray (e.g., slot 1-1, 1-2, 2-1, 2-2 on tray 503), the current height of a stack of tray (may related to how height an tray, e.g., an empty tray should move to another tray stack), and the set inspection position in front of the inspection camera. The virtual objects may include a data structure to maintain these parameters, which may include static parameters, e.g., the configurable sizes of the virtual workpiece, and indexes of the virtual objects which may be updated in a simulation according to the process flow, for example, how many layers of a tray are stacked in a certain step of the process, or what is the next empty slot on tray 505 to put with workpieces. The coordinates in a specific coordinate system, for example, the coordinate system of the virtual objects, may cooperate with the indexes to automatically generate the latest position and orientation of virtual objects, and a desired position and orientation of them in the next step of the process, and the desired motion paths of virtual objects can be generated. After the desired physical movements of the virtual objects are generated, the desired motion and action of the robot can be generated based on the generated physical movements, for example. Then, the robot program and/or a virtual agent program may be generated.

The traditional methods of robotic automation process building rely heavily on programming the robot's motions and actions which make users unable to focus on the automation target and many additional efforts are spent to program the robot to achieve the desired process of the workpiece. According to the disclosed user interface, users can fully focus on the desired automation process. Referring to FIG. 7, although a robot or a workforce is not yet assigned, the automation process has already been built, visualized and can be checked. Then, users just need to assign a workforce to the automation cell or the process flow, to handle some or all processes. Furthermore, in a traditional method, users need to take care of the coordinates of the robot first and then those of the objects, which brings a lot of effort and usually needs many additional manual calculations. The disclosed methods may define the automation process first, which is defining the change of the status of a workpiece and then generating the motion and action of the robot, rather than starting from the programing of a robot. This is the key to reducing the effort of building an automation cell/line and is one advantageous difference compared to the existing systems or methods.

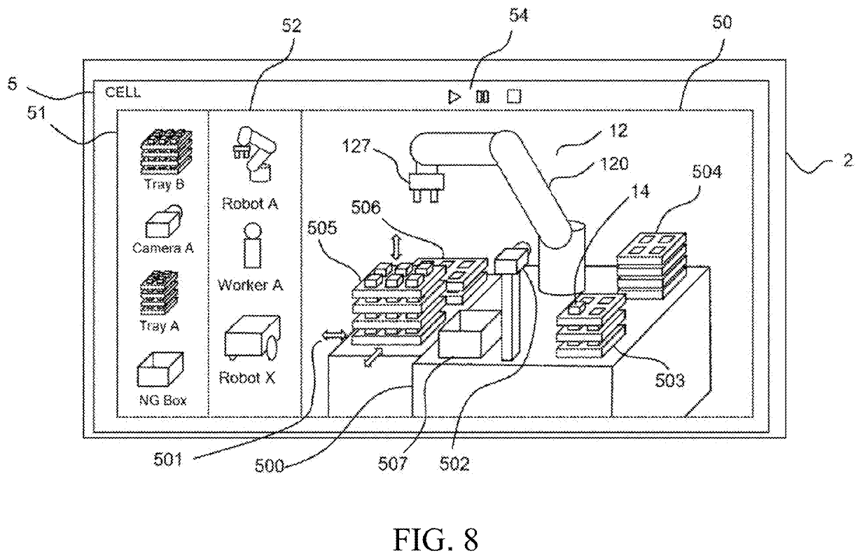

Referring to FIG. 8, the user interface 2 may provide a workforce list 52 for users to assign a workforce to the automation cell. The workforce may be a robot or a human worker. If desired, users may drag and drop the workforce to the cell space 50 to assign the workforce to the automation cell and place it in a position in the cell space 50. For example, a workforce “Robot A” which is a virtual robot 12, may be put to the cell space 50. Because all desired motion and/or process of the virtual objects to be handled by a workforce have been configured and generated, virtual robot 12 may generate all its motions and actions to handle the virtual objects, e.g., the workpiece 14, with all related parameters and indexes of the virtual objects, the coordinates of the virtual objects, the gripper-to-workpiece relationship, e.g., the gripping point, the griping depth, the gripping orientation, etc., which may be configured in a workpiece configuration interface, and the forward and/or inverse kinematics of the robot arm 120. For example, by referring the process flow in FIG. 5, the “SOURCE” block indicates Workpiece A comes from Tray A, and the initial status of Tray A may be seven layers. So, the first targeting point of the virtual robot, which may be the tool center point of the gripper 127, to reach is above the slot 1-1 of the topmost layer of tray in Tray A. Then, the motion to pick the first workpiece may be generated with a linear motion (e.g., the LINE command in FIG. 1) perpendicular to the virtual table 500, while the end points of the linear motion may be generated according to a planner position with coordinate X and Y of the first workpiece slot in Tray A and a height Z that is calculated according to the height of seven layers of stacking tray, the depth of the slot of the tray, the height of the workpiece, the gripping point, the griping depth, and the gripping orientation of the workpiece.

The process flow in FIG. 3 or FIG. 5 may not include a flow block named with “PICK” because the robot code may be generated according to the process flow behind the “SOURCE” block. For example, when a process flow indicated “The workpiece comes from Tray A, should be (firstly picked and then) placed to a pose . . . ”. So, for changing the positional status of a workpiece, the robot knows it needs to pick up a workpiece first from the source or the last position of the workpiece, e.g., after one or a series of “PLACE” blocks. Through neglecting the flow block for picking, the process flow may be simpler and clearer.

In the steps of picking and placing, the robot may need to open and/or close the gripper 127, for example, when picking a workpiece 14 from tray 503, gripper 127 should open its fingers first, then lower its vertical position (e.g., by robot arm 120) to the picking depth of the workpiece, and then close the gripper to grip the workpiece. Actions of opening and closing the gripper may be performed by robot 12 with its digital inputs/outputs, or a communication with gripper 127, like the robot code “DO3-HIGH” in FIG. 1. These motions and actions may also be generated autonomously according to the process flow and the parameters and indexes of the virtual objects in the cell. The branches of “OK” and “NG” in the process flow in FIG. 5 may also be used to autonomously generate the robot code like “IF”and “ELSE” shown in FIG. 1.

If desired, the autonomous robot code generation may be a modular function to each of the flow blocks and may be constructed by a script or a template of a parameterized robot code.

The robot code generation function may largely reduce the effort to program a robot. For example, during the handling of a tray stack and its coupled empty tray stack, because the heights of these two tray stacks may rise and fall, if the robot code is not well programmed, the robot arm is very easy to collide with one of the tray stacks. In robot-code-based programming, users need to establish complicated mathematical formulas to prevent that. However, in the disclosed system and methods, the user interface may integrate the algorithms or formulas which work dynamically according to the updates of the parameters and indexes of the virtual objects.

User interface 2 may further include a path generation function, to autonomously generate a motion path of the robot arm 120 between the desired poses. In some embodiments, the path may be a collision-free path to prevent a collision to the virtual objects according to the latest updated status of cell space 50, e.g., the updates of the positions and orientations of virtual objects. The occupational data needed for the collision-free path planning may be provided by the geometric model of the virtual objects, or a simplified bounding box of the virtual objects. The collision-free path generation may utilize some existing technologies, e.g., Rapidly Exploring Random Tree (RRT). The path generation function may bring benefits to the applications in which the real objects may be dynamically moving, which may be hard to deal with through conventional robot code programming even when they are sensed or localized by sensors.

The autonomous robot code generation may be included in the physical controller of a robot, the user interface 2, or a virtual robot controller. Robot code may be generated at once before running, or step by step when robot is running. In the case of generating all robot codes prior to running, the robot code generating parts of the system may generate robot codes with variables to be filled in when the simulated cell updates the parameters of indexes of the virtual objects. For example, a 2D or 3D camera is set in the cell to update the position of the inputting workpiece, which may not be a fixed position on a tray, then the coordinates for picking the workpiece may be generated with parameters like X, Y, and Z, waiting for the camera to update the real number when running.

Referring to FIG. 8, the user interface 2 may provide a simulation function, for example, providing a program running panel 54 for users to run the simulation of the automation cell after the robot code is generated. Basically, the users only need to create virtual objects, place them in a virtual cell, set the process flow, assign the workforce (e.g., a robot), and after pressing a “PLAY” button in program running panel 52, they can see and check how does the automation cell works, with no need to do any robotic programming. If desired, a collision detection function may be provided to check the collision between the model of the virtual objects, the gripper, and the robot arm, which reduces the efforts of manual checking.

In all these operations described above, users don't need a mechanical engineer to produce any CAD files, and don't need a robotics engineer to write any robot code. This largely reduces the efforts of the concept-building of an automation task. Furthermore, because each virtual object has an initial parameter set, users don't need to set them one by one to make them work. Users just need to drag and drop the virtual objects with their initial parameters to start the simulation of the automation cell for a first check and then add the details by further configuring the virtual objects. In the simulation of the process flow, the cycle time (i.e., the timespan for a workpiece to travel in the process from input to output) or the tick time (i.e., the time interval between the outputs of the workpieces) may be calculated or analyzed by user interface 2. A bottle neck analysis may be provided by listing the cycle time in each process.

If there are some issues found or shown in the simulation, for example, a reachability issue of the robot arm 120, users can quickly move the icon 501 to adjust the position of a virtual object, and press “PLAY” again to quickly check the result. When the user interface 2 is running in the robot's controller, two different kinds of functions might be provided for “PLAY”: running a real or a virtual robot, which may be switchable. The two modes may bring benefits to the users. For example, for a minor change to the original flow/cell setting validated with a real robot, users may like to run with the real robot directly. For a larger change, users may like to quickly run with the virtual robot (which may be also provided in the robot's controller) first to prevent possible issues. When a real robot is running, user interface 2 may still visualize the simulation of the robot and the automation cell, which can also be seen as a digital twin of the robot or the automation cell. If desired, when in running the program with a simulated or a real robot, the “FLOW” page may also be accessible by users (e.g., but potentially not the “CELL” page), and user interface 2 may provide a feature to highlight the current process, e.g., the current flow block glows in the “FLOW” page in sequence.

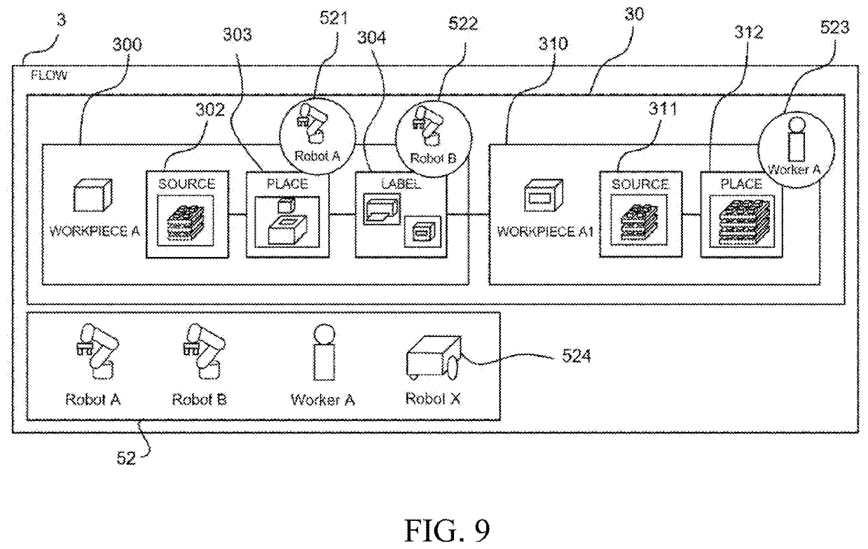

Although not shown in the figures, user interface 2 may include different kinds of robots. For example, a SACRA (selective compliance assembly robot arm) robot, a DELTA robot (a type of parallel manipulator), an X-Y-Z robot or an X-Y-Z stage, a dual-arm robot, a humanoid robot, an AGV (Autonomous Guided Vehicle), a mobile robot driven by wheel(s) or legs, or an AMR (Autonomous Mobile Robot), which may be the combination of a robot arm and a mobile platform. The transportation and loading of the input trays to the automation cell may be performed by a mobile robot 524. Referring to FIG. 9, if desired, mobile robot 524 may be assigned to flow block 302 for filling the input trays.

The user interface may provide a function for users to align physical features between the real world and the simulated automation cell. For example, to remove the dimensional or the positional gap between the real assembly of the automation cell and the simulated one, user interface 2 may provide a key point alignment function in the simulated cell space 50. The key point alignment function may highlight the key points on the virtual objects, e.g., the eight corners of a box-shaped virtual object, the center of the slots of a tray, or a specific marked feature on a virtual object which is sometimes referred to “calibration points”. A step-to-step guidance may also be provided for the user to operate robot arm 120 to align its tool center point to those key points in the real world, for example, the corner points 481, 482, and 483 in FIG. 6 in a sequence, and return the robot's coordinate of the tool center point to user interface 2. Through updating the coordinate of the key points in the virtual object one by one (e.g., corner point 481 first, then corner point 482 and 483, the actual position and orientation of a virtual objects may be obtained and be updated in cell space 50. Due to the X, Y, Z coordinate of these three corner points brings totally nine constraints (3 multiplied by 3) which is larger than a six degree of freedom, and the alignment of the tool center point can't be perfect in physical world, a least squares method may be used to have a best matching result. If the robot is equipped with a camera, or there is a camera set in the cell, the coordinates of the image features of a cell object provided by the camera may be used to perform the calibration for the virtual objects.

Furthermore, user interface 2 may provide the virtual model of calibration-related features or parts for the users: a specific geometric features on the object, a calibration jig which may be a specific parts mounted in the tool end of robot arm 120 or gripped by gripper 127 (e.g., FIG. 4) that matches the geometric features of the specific geometric features for the calibration on the objects, or a visual land mark for the camera to align with. Through placing or attaching these calibration-related features or parts to the virtual objects or the robot in cell space 50, the efforts for users may largely be reduced to perform a calibration because the user interface 2 has a complete coordinate system management system for the virtual objects and robots. On the other hand, the relationship between different coordinate systems is automatically calculated or updated, which advantageously may relieve users from having to manually perform such tasks.

If desired, the suggested positions of the virtual objects may be autonomously generated according to the motion range of the workforce and the access points on the virtual objects, e.g., all slots in a tray stack when placing the established virtual objects, or a one-click generation to place all established virtual objects at once.

Referring to FIG. 9, the process flow canvas 3 may include more than one workpiece flow island, for example, workpiece flow island 300 and workpiece flow island 310. The process flow in FIG. 9 may represent the same labeling process shown in FIG. 3, but defined the labeled workpiece as a new workpiece “Workpiece A1” which may have its own workpiece island 310. This example of the design of the process flow shows a possibility to define a new workpiece when the workpiece's status, specification, or character changed. This kind of design may provide benefit to the users if the change of status, specification, or character is important to the management of the automation process. For example, if a workpiece is to be fixed with four screws, a new workpiece may be generated to represent the workpiece after all four screws are tightened. The end of a workpiece flow island may also be seen as the end of the life cycle of a workpiece, for example, in FIG. 9, workpiece flow island 300 ends after Workpiece A is labeled, indicating the life cycle of Workpiece A is ended in the process, and in workpiece flow island 310, a new workpiece (i.e., Workpiece A1), is generated and starts its life cycle. The setting of generating new workpiece (e.g., Workpiece A1) after a specific process may be provided in a setting interface of a flow block like the flow block 304 in FIG. 9.

Referring to FIG. 9, the process flow interface or “FLOW” 3 may provide the workforce list 52 for the user to drag and drop different workforces to the flow block's workforce slots 521, 522, or 523. For example, Robot A is assigned to place the workpiece onto a jig, Robot B is assigned to pick the label from a label machine and stick it to the workpiece, and a human worker (Woker A) is assigned to place the labeled workpiece to an output tray. In this case, cell space 50 in “CELL page” may include all three workforces: Robot A, Robot B, and Worker A, which are placed in different positions in the cell. In the simulation, all these workforces may work together according to the process flow.

If desired, the human worker's motion and action may be generated and simulated. If the focus of the system is the robot, the motion and action of the human worker may be replaced by a looping animation, and the cycle time of the motion and action of the human worker may be set directly by the user. In a human robot collaboration scenario, the motion and action of a human worker may be important to analyze with the motion and action of the robot. In this case, other than using kinematics of a human body to generate the motion of a human worker, user interface 2 may include a function to import or produce the motion capture data with the real person, through offline methods (record and play) or online methods (in a real time data transmission). The latter may benefit the iteration of the optimization analysis for the human-robot collaboration, by putting together the motion of a virtual or real robot and a real time motion capturing of a human worker (e.g., in a safe position or at the working station without a real robot). The simulation of the human workers may also include the movement on the floor, e.g., entering and leaving the automation cell. If desired, user interface 2 may include models of safety sensors, e.g., safety light curtains, safety bumping sensors, safety lidars, and safety radars, mounted in the automation cell or on the robot. In the application of a human-robot collaboration, the robot may be equipped with a power and force limiting (PFL) function or a speed and separation monitoring (SSM) function to reduce the risks in the application. The simulation may include the interaction between the robot and human workers, e.g., the human workers entered the set safety distance of a robot, and the robot reduced its speed, or stopped. This kind of analysis may be evaluated if the safety settings (e.g., the coverage of the safety sensors) are comprehensive (e.g., by set a random translation path or action of the virtual human worker to see if the set safety sensors has a dead zone), and may also be used to evaluate the productivity and benefit of the cost, e.g., the cycle time and footprint (e.g., with or without fences) of a human-robot collaboration automation cell.

If desired, a mobile robot 524 may be assigned to flow block 302, which may mean mobile robot 524 is responsible for refilling the input tray stacks with the workpieces when all of them are run out of in the automation process. In this case, user interface 2 may also generate the robot code, the task, or the event of the mobile robot 524, or the handshake of mobile robot 524 with the automation cell, or the manufacturing execution system (MES).

The handshake between these workforces may be autonomously generated according to the process flow, for example, the digital I/O connection or communication between robots, the digital I/O of a button for the human worker to press, or a gesture/voice of the human worker sensed by a robot to initiate handshaking. In a multi-robot case, user interface 2 may be provided in a cloud server, which may include virtual robots and virtual human workers. The generated robot code can be transmitted or loaded to the real robots. If desired, wiring instructions of the handshake (e.g., digital I/O) may be generated according to the robot codes, which is helpful in installing the physical robots. Other than the motion, action, handshake mechanism of the workforces, if desired, the disclosed the robotic system and method may also generate the machine code of automation components, e.g., a machine code of Programmable Logic Controller (PLC) to communicate with workforces and/or sensors in the work cell and communicate with the Manufacturing Execution System (MES).

Referring to FIG. 3 and FIG. 8, to enhance the usability of the user interface 2, a bi-directional flexibility of setting and configuration between “FLOW page” and the “CELL” page may be provided. For example, users who prefer to start from establishing the flow process may start from the “FLOW page” to drag and drop the flow blocks to the process flow canvas 30, establishing the virtual objects and workforce and assigning them to the flow blocks. Afterward, they may place them from the established virtual object list 51 to the cell space 50 in the “CELL page”. Users who prefer to construct the automation cell with the physical visualization may start from the “CELL” page to establish virtual objects and workforce first and place them to the cell space to have an initial physical visualization of the automation cell. Afterward, they may go to the “FLOW page” to establish the process flow and assign the established virtual objects and workforce to the flow blocks. If desired, every single step of these operations may be performed independently, and users can switch between the “FLOW page” and “CELL page” with ease to have a fully bi-directional configuration and a flexible user experience.

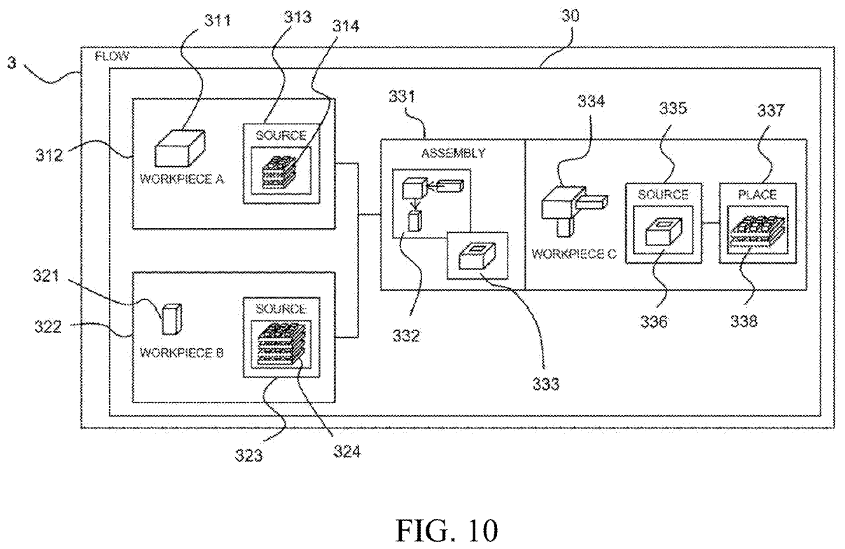

Referring to FIG. 10, the user interface may provide a function to have more than one workpiece in the process flow and may provide a function in the process flow to join more than one workpiece to establish a new workpiece, for example, the assembly flow block 331 (sometimes referred to herein as “ASSEMBLY” block or “ASSEMBLY” flow block) for the assembling applications. Referring to flow canvas 30, users may first establish a first workpiece 311 which is Workpiece A, and a second workpiece 321 which is Workpiece B, where each of them may have their own workpiece flow islands 312 and 322. The user may establish an assembly flow block 331 to be coupled with workpiece islands 312 and 322, for example, to choose workpiece flow islands 312 and 322 when establishing assembly flow block 331 (e.g., linking the connection lines of workpiece flow islands 312 and 322 to the assembly flow block 331). When assembly flow block 331 is established, a new workpiece 334 may be established automatically at the same time, which is the result of assembling workpiece 311 and workpiece 321. Users may name it as Workpiece C. Assembly flow block 331 may have an icon of visualization of the how the one or more workpiece 311 and workpiece 321 are assembled. For example, the visualization may include an animation of the assembly process 332, and have a slot to assign the assembly jig, for example, assembly jig 333 to assemble those workpieces to a fixed position, which is necessary when using a single robot arm to perform the assembly application.

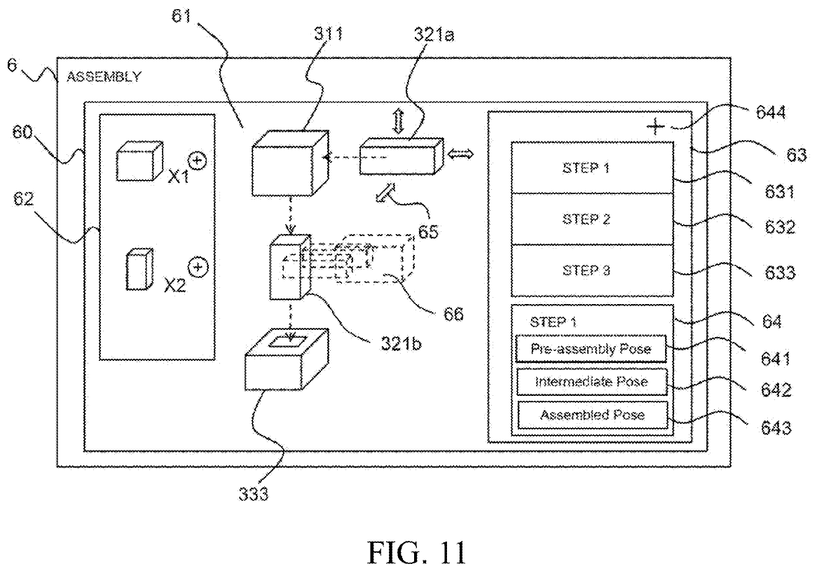

Referring to FIG. 11, after workpiece 311 and workpiece 321 are assigned as the materials of assembly flow block 331 to generate workpiece 334, the user interface may provide an assembly process interface 6 for the user to define how to assemble a workpiece 334 by one or more workpiece 311 and workpiece 321. For example, the assembly process interface 6 may include a visualization of the assembly jig 334, and a list of assembly material 62 (sometimes referred to herein as assembly material list 62). Users may drag and drop the workpieces in the assembly material list 62 to establish assembly steps 63, e.g., assembly step 631, 632, and 633, in an assembly step list 63. If desired, assembly material list 62 may provide a function to bring more than one of the same workpieces to the assembly. That is, the assembly of a workpiece may include one workpiece 311 and two of workpiece 321, e.g., visualized workpiece 321a and 321b. The number of each kind of assembly material may be previously defined when establishing the assembly flow block 331, and if desired, may be changed in the assembly material list 62.

In step 631, 632, and 633, which a user may add through pressing the plus mark 644, the relative position and orientation of the workpieces may be defined through moving a workpiece with manipulation bar 65, or through clicking the geometric features on the model of the visualized virtual workpieces to snap or align them. A step of assembling may be constructed by multiple assigned poses (while poses may mean the combination of position X, Y, Z, and orientation RX, RY, RZ). For example, an interface 64 may be provided to set the details of Step 1, and users may establish a pre-assembly pose 641, one or more intermediate poses 642, and assembled pose 643 (e.g., after jogging the workpiece to a desired position, and press button 641, 642, and 643 of the poses) at the end. These poses may be assigned with different kinds of motions, for example, the linear, circular, or helicoidal motions. Intermediate poses are sometimes important when describing a more complex assembling action. Other than assigning the poses of a workpiece as an intermediate pose, if desired, the intermediate pose may also be able to be established by assigning the movement of the gripper, for example, use the gripper to open a hatch, to push or rotate a locking mechanism for completing an assembly step. In some embodiments, a visualization of the gripper 66 may be advantageously provided in the interface. After the user sets one or more assembly steps, the interface may provide a function to be visualized as an animation of one or more assembly steps for users to check, which may include the visualization of the gripper 66, and may include a collision detection function.

In the case shown in FIG. 10, when the process flow 30 is running, the sequences of the highlights of the flow blocks (e.g., the flow block may glow in a sequence) may be automatically generated according to the configuration set in the assembly block 331. For example, when running the process flow 30, the first highlighted block may be workpiece flow island 322 or flow block 323, because the first step to assemble a workpiece 334 is to pick a workpiece 321 shown as workpiece B. The second highlighted block may be flow block 331, i.e., the assembly block, to perform the assembly. The third highlighted block may be workpiece flow block 312 or flow block 313, because step 2 of the assembly required a workpiece 311 shown as Workpiece A. The fourth highlighted block may be flow block 331 again to represent the step 2 of the assembly. The fifth highlighted block may be workpiece flow island 322 or flow block 323 again, because step 3 of the assembly required a workpiece 321 again. From this point of view, the process flow may be provided with a logical architectural definition in the user interface, which used the reduced or near minimum amount of description to define the process, instead of a pure time-sequence based description, which usually results in the complicated and long process flow. The above described techniques may produce a significant advantage over typical robotic programming, for example. Furthermore, when the amount of assembly material, e.g., workpiece 311 or 321 on tray stack 314 and 324, is fully taken, the process flow may indicate a workforce to remove the empty layer of the tray to access the workpieces in the next layer of it. This may be a very challenging and time consuming action to program in typical robotic code programming, especially when the number of slots in tray 314 and 324 does not match the consumed amount or rate of workpieces in the assembly, for example.

A user interface according to some embodiments may also provide a disassembling function of a workpiece. For example, a user interface may be used to define an assembled workpiece (e.g., directly putting all parts into the assembled position, or loading from a CAD assembly file), and may provide a disassembly flow block similar to assembly flow block 331 but generate workpieces instead of combining the existing workpieces. While in the disassembly flow block, an interface similar to the assembly interface 6 in FIG. 11 may be provided for the user to define the steps, paths, poses, and actions to disassemble the workpiece. Furthermore, if the assembled workpiece is defined from an assembly with a data structure of the assembly steps, for example, assembled via the assembly interface 6 in FIG. 11 in another project of user interface 2, the disassembly flow block may automatically generate the disassembling steps which may be a direct reversed sequence of the steps, paths, poses, and actions from the assembly. At the same time, for a workpiece defined with disassembly steps, the process flow may automatically generate the steps of assembly according to the disassembling steps, paths, poses, and actions. Embodiments including reversable assembly-disassembly/disassembly-assembly automation may be a significant advantage over traditional robotic programming which needs many manual programming to establish the actions of robot for both assembly and disassembly, for example.

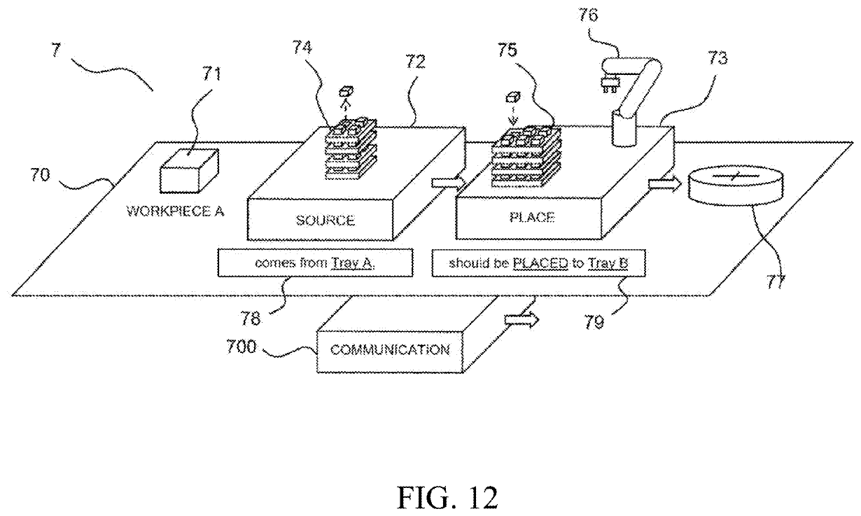

Referring to FIG. 12, the visualization of the process flow may be presented in a three-dimensional way. The three-dimensional process flow 7 may be constructed by the three-dimensional visualization of workpiece flow island 70 and flow blocks 72, 73. Workpiece 71, tray stacks 74, 75, and the workforce 76 may be shown in a three-dimensional way. A flow icon 77 may represent an empty slot to add more flow blocks, for example. The advantage of a three-dimensional process flow presentation may be easier for users to recognize the virtual objects shown also in a 2-dimensional “CELL” page, for example. Furthermore, a three-dimensional space may be used to represent more information of the process flow than in a pure two-dimensional space. For example, an assembly block (not shown in FIG. 12), which may be different from other flow blocks in the function, may be put in a higher position to the regular flow blocks. Taking another example, flow block 700 may be a flow block representing a parallel process flow (e.g., communication between a local controller to a manufacturing execution system (MES)) and may be put in a layer lower than the main process flow. Furthermore, the descriptions 78 and 79 may be provided in the same interface to help users to understand the meaning of the flow blocks, while hyperlinks in the description may be used to enter or open some functional interfaces, e.g., clicking the underlined text “Tray A” in the description 78 may enter the configuration page of tray model 74, just like to click the visualized tray model 74 on the flow block 72.

Some embodiments of a user interface may provide a function to generate CAD files of the configured virtual objects. In this way, the configuration of the virtual objects which has been already validated in the simulation, can be provided to a mechanical engineer for a design of manufacturing. The generated file may be a three-dimensional CAD file, a two-dimensional CAD file, a mechanical drawing, or a document with a two-dimensional or three-dimensional figures marked with dimensions. Mechanical engineers can keep those parameters of the validated virtual objects and perform further optimization in the CAD software to reduce the weight by removing materials which will not affect the automation process or adding chamfers to the edges. This may largely reduce the efforts of the mechanical engineers, who are usually assigned to generate the first version of the CAD file to simulate and then have multiple iterations of modification in different stages of designing an automation cell to finally produce a workable set of mechanical parts for the automation cell.

In some embodiments, user interface may include different models of virtual objects for different manufacturing methods. For example, the system may include a tray model intended to be manufactured by 3D printing, vacuum forming, or machining. Models for different kinds of manufacturing may have different configurable parameters, different kinds of generated CAD files, and different ways of markings in the mechanical drawings. An export and import function may be integrated into the user interface for the virtual objects to be reused in different projects or different automation cells/lines.

If desired, some embodiments of a user interface may provide a function to automatically generate the bill of material (BOM) of the mechanical parts and may further have a function to evaluate the cost of the mechanical parts or industrial components (e.g., a robot, a conveyor, or a gripper). For example, including a price table for the industrial component and having a function to calculate the cost of the machined parts or 3D printing parts based on their volume, dimension, and geometric features (e.g., subtractive manufacturing for a metal tray: how many slots needed to be milled), manufacturing methods (e.g., machine cutting: turning or milling, 3D printing: SLA, stereolithography; FDM, fused deposition modeling, or Selective Laser Sintering, SLS) and material (e.g., steel or aluminum; or 3D printing: PA, polyamide/nylon; PLA, polylactic acid/polylactide; or ABS, acrylonitrile butadiene styrene). User interface 2 may also have a function to evaluate a land cost based on the footprint of the automation cell. From the simulation of a human worker, the labor cost in the process flow may also be generated. Then, by analyzing the total cost compared to the cycle time or tick time generated in the simulation, the user interface may provide a return of investment (ROI) analysis for users to evaluate the design of the automation cell and optimize the automation ROI. For example, adding a second gripper to level up cycle time, changing the material or reducing the volume of specific virtual objects to reduce the manufacturing cost, or minimizing the footprint of the automation cell to reduce the land cost. The price table may be configured by the users to better match their local marketing prices around the world.

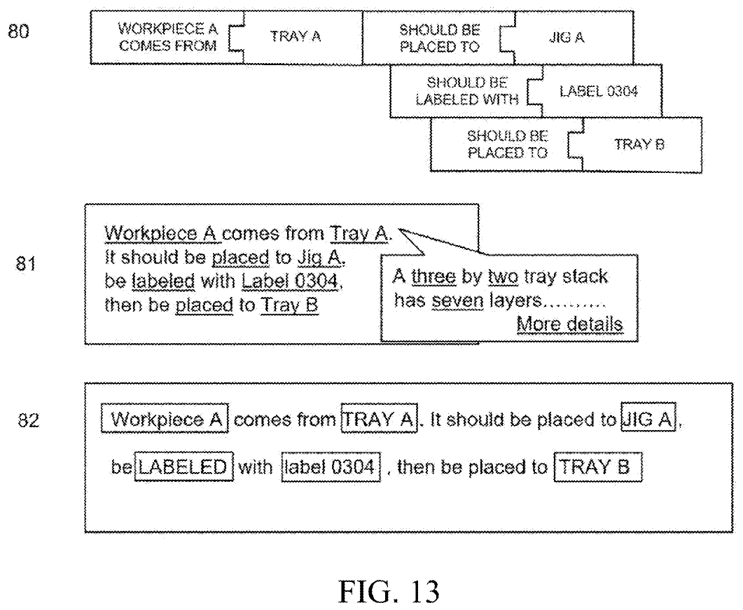

FIG. 13 illustrates another example of a process flow according to some embodiments. Other than the graphical methods shown in the previous figures, a process flow may be presented and constructed with a more text-based description which may bring benefits as a clearer interface. For example, a ticket-type or a block-text-type process flow 80 may include tickets or blocks that are printed with names of the virtual objects, and/or the descriptions in the text for the process, e.g., “SHOULD BE PLACED TO” may equal to the flow block 303 or 305 as the “PLACE” flow block. The tickets or block of the text may be re-assembled with each other to establish a process flow. Further configuration may be provided as pop-up windows when pressing each ticket or block of the text. For example, pressing the ticket marked with TRAY A to enter the configuration interface of TRAY A. Also, a fully text-based interface 81 may be provided by in a user interface in which users may input those descriptions by typing. A user interface may include a function to analyze the text that users input to define the process flow, and the hyperlink (i.e., the underlined words) may be provided with specific key words. As the mouse cursor moves over or clicks, the next layer of information and configurable parameters may show. A text-graphical hybrid process flow interface 82 may be an example of the combination of interface 80 and 81.

Referring to the text-based interface 81, the user interface may include a simpler but more restricting function to analyze the user input, in which users can only input the allowed characters and key words. A user interface may include a more powerful recognition and translation function like Natural Language Processing (NLP) to analyze the user input in natural languages, e.g., utilizing AI (Artificial Intelligence) technologies such as Artificial Neural Network (ANN), machine learning, deep learning, Large Language Model (LLM), and/or AI Agent. If the system is equipped with such capabilities to recognize and understand natural languages, the user interface may provide a more interactive function to respond to the users. For example, users give a request of automation process with the natural language, via typing or speaking, and send text or vocal description to the user interface, (e.g., via e-mails to the user interface running on a cloud device, or an AI agent in the user interface). The user interface may analyze the request and generate one or more automation cell simulations or a proposal of possible automation solutions (e.g., depending on the details the user described; for those not described in detail, use the initial parameters or default templates to create the virtual objects) with cycle time, tick time, bottle neck analysis, bill of material, and ROI analysis, and briefing the package to users via text or vocal means. Users may provide feedback with some requests for modification and have the following iterations of interactions with the user interface 2. As such, the product usage scenario is transformed from operating the user interface to a more interactive and intelligent way.

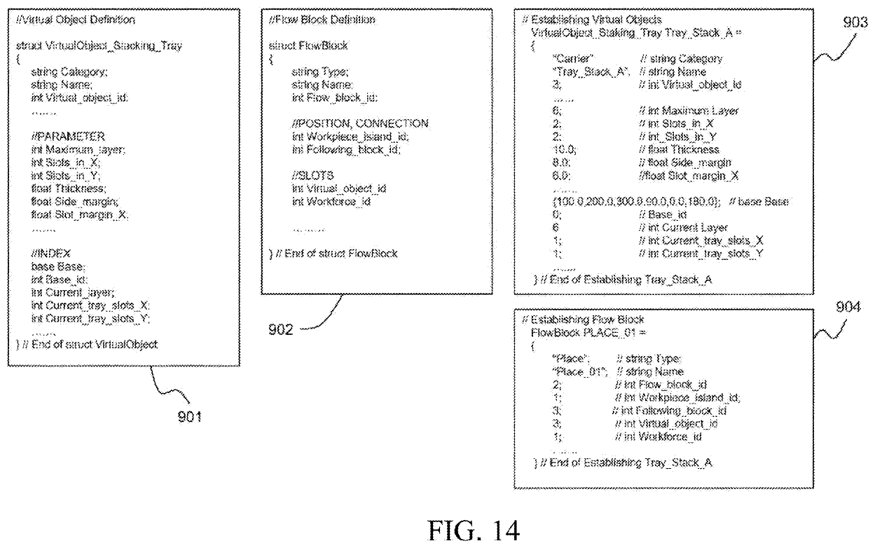

Refer to FIG. 14 for examples of the implementation of program codes of the robotic system or the programming method. Program code 901 shows an example of a program to define a virtual object in a structural way based on an Object-Oriented Programming (OOP) method. The examples of the program codes in FIG. 14 only show a possible expression of the programming, which may not belong to a specific existing programming language. One of ordinary skill in the art of programming can find similar expression or functions in existing programming language, e.g., C language (Combined Programming Language), C++, C#, Python, Java . . . etc. In program code 901, a type of virtual object “Stacking_Tray” may be described with a structure (“struct”) which may include a string type data “Category” for describing the category of the virtual object, e.g., workpiece or carrier. The category data may be used to quickly check the category of the virtual object in some function, for example, checking if the virtual object is allowed to be placed in the specific slot of a flow block. For example, a “PLACE” flow block's slot may only allow it to be put in a carrier-type virtual object. A string type “Name” may be included for the name of the virtual object to be shown on the user interface 2. Then, a group of parameters may be included in the structure to describe the configurable data of the virtual objects; for example, an integer type (“int”) data “Maximum_layer” describes the maximum layers that a stacking tray can stack. “Slots_in_X” and “Slots_in_Y” describe the number of slots on a tray to carry workpieces in its X and Y directions. Finally, a group of indexes may be included to maintain the status of the virtual object. Indexes may be changed within the program's execution according to events in the process flow. Index “Base” of a “base” type data may include six coordinate values for the coordinate system, for example, X, Y, Z, RX, RY, RZ. The “Base” may describe the position and orientation of the virtual objects within a coordinate system, for example, a world coordinate system (e.g., set “Base_id” to zero for basing on world coordinate) or a coordinate system established on another virtual object, for example, a coordinate system established on a label machine at the position of its output position of labels. An integer “Base_id” may describe which coordinate system the virtual object is based on. The “Base” value may change when the virtual object is moved in the flow process, while the “Base_id” may change when a virtual object is moved to another virtual object, e.g., moved from a table to a conveyor. Indexes “Current_layer,” “Current_tray_slots_X,” and “Current_tray_slots_Y” may describe what current reachable layer of the tray (e.g., the topmost layer) is and the current intended slot for the workforce to operate with a tray. The “Current_layer” of an input tray stack changes when its topmost tray is emptied and is moved to the empty tray stack; for example, one layer reduced. The “Current_layer” of an output tray stack changes when its topmost tray is fully loaded and an empty tray is added to its top, for example, one layer added. “Current_tray_slots_X” maybe 1 and “Current_tray_slots_Y” may be 1 of a tray when initialing, which may mean the tray slot 1-1 in a form of array and may be shifted to slot 1-2 or 2-1 after a workpiece at slot 1-1 is taken in an input tray, or an empty slot 1-1 is filled with workpiece in an output tray.

Referring to FIG. 14, program code 902 shows an example of defining a flow block in the process flow. The structure may include the type of the flow block, e.g., a “PLACE” flow block or an “Inspection” flow block. An integer “Flow_block_id” may be included to number the flow block. If desired, data for describing the position of the flow block or connection relation between the flow blocks may be included; for example, “Workpiece_island_id” may describe the flow block is located on which workpiece island in the process flow user interface, and the “Following_block_id” may describe what is the flow block connected behind this flow block. In the case of having a branch behind a flow block, the “Following_block_id” may be an array of data. The description of “Following_block_id” may cover the cases of a branching of process flow or a merging case after branched. For example, a process flow is constructed by flow blocks 1,2,3 and 4 (each has a block id 1,2,3, and 4), while flow block 1 branches to flow blocks 2 and 3, and process flow behind the flow blocks 2 and 3 merges to flow block 4. In this case, the “Following_block_id” of flow block 1 may be an array [2, 3], and the one of flow block 2 and 3 is [4]. According to different program architectures, the description of position and connection between flow blocks may be described in an individual definition file of process flow. “Virtual_object_id” and “Workforce_id” may describe the assigned virtual object and workforce to the slots of a flow block.

Program codes 903 and 903 show examples of establishing a virtual object and a flow block by constructing them first according to the definition structure of them and then assigning the values of the structure members. For example, program code 903 may express: establishing a virtual object “Tray_Stack_A” according to the structure “VirtualObject_Staking_Tray,” with the category “Carrier,” name “Tray_Stack_A,” is the third virtual object being established, has a maximum of six layers, has 2 slots in its X direction and 2 slots in its Y direction, has a thickness of 10.0 mm . . . etc., has a relative position X=100.0 mm, Y=200.0 mm, and Z=300.0 mm, and a relative orientation RX=90.0 degrees, RY=0.0 degrees, and RZ=180.0 degrees to a coordinate with number 0 (“Base_id: 0”), and its current reachable layer is the sixth layer, and the intended tray slot to operate with is slot 1-1. The parameter “Maximum Layer,” “Slots_in_X/Y,” “Thickness,” “Side_margin,” and “Slot_margin X” may be configured in the “OBJECT” page of the user interface 2. The indexes “Current_Layer,” “Current_tray_slots_X,” and “Current_tray_slots_Y” may be set with default values when established and updated in events of execution of the process flow. If desired, as an advanced feature, they may be configured by the user for the cases of an abnormal stop happening in the execution of the project, and the initial values of them are different from the default values when need to restart, e.g., half slots of an input tray is emptied and not refilled manually. Indexes “Base” and “Base_id” may be set in the “CELL” page when placing a virtual workpiece in the cell space and may be updated according to events in the process flow like the virtual object is moved or is put to the top of another virtual object. Program code 904 shows an example of establishing a flow block in a process flow with a type “Place” (i.e., a “PLACE” flow block), a name “Place_01”, is the number 2 flow block established by the user, locates in the first workpiece island, has a flow block number 3 connected behind it, assigned with virtual object number 3 and a workforce number 1. The “Workpiece_island_id,” “Following_block_id,” “Virtual_object_id,” and “Workforce_id” may be assigned automatically when the user drags and drops a flow block from the flow block list to a process flow, and updated when the user changes the move the position of the flow block in the process flow or changes the assigned virtual objects or workforce to it. If desired, a special number may be assigned to “Following_block_id” to describe there is no flow block behind it, e.g., minus one (−1).

If desired, an advanced program code may be implemented by more layers of structure, like the “class” function in the C++language, which has an “inherent” function that can prevent repeated program coding. For example, to construct an object in programming (in Object-oriented programming, for example, the “class” in C++) of a virtual object structured with those general parameters or indexes of a virtual object, e.g., “Name” and “Virtual_object_id,” as the base object. Then, construct its derived object which inherits the base object. For example, in C++, use “class virtual_object” to establish the base object and use “Stacking_Tray: virtual_object” to establish a derived object, while the notation “:” means the inheritance. The derived object inherits those parameters and indexes of the base object. It can structure the specific parameters or indexes of its type, for example, the slots of a tray or layers of a stacking tray. This implementation way may bring the advantage of having a more structured program code and easier to expand the contents of program objects.

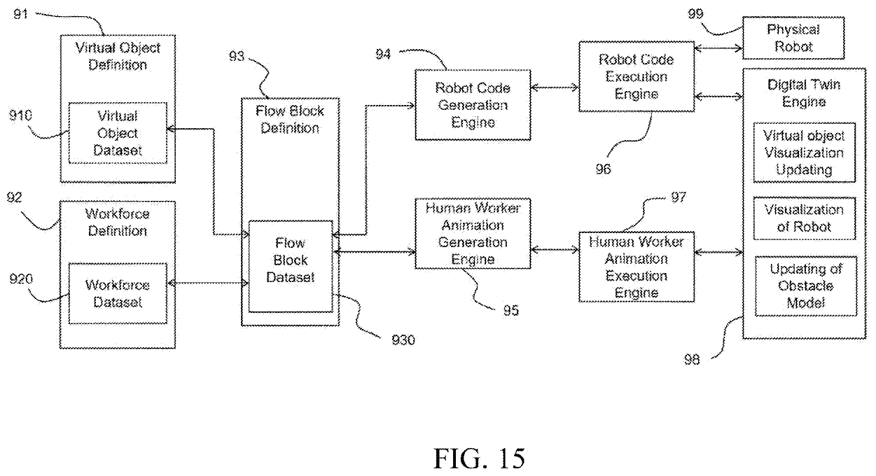

Referring to FIG. 15 for an example of the implementation of the software architecture of the robotic system or the programming method. Virtual object definition 91, workforce definition 92, and flow block definition 93 may represent architectures to define a virtual object, a workforce, and a flow block. Examples of program codes of the virtual object definition 91 and flow block definition 93 are introduced in program codes 901 and 902 in FIG. 14. Virtual object dataset 910, workforce dataset 920, and flow block dataset 930 may represent the dataset of a virtual object, a workforce, and a flow block, established according to virtual object definition 91, workforce definition 92, and flow block definition 93. Examples of program codes of virtual object dataset 910 and flow block dataset 930 are introduced in program codes 903 and 904 in FIG. 14. Robot code generation engine 96 is the core of the software architecture, and flow block dataset 930, workforce dataset 920, and virtual object dataset 910 provided all the necessary information of a virtual work cell for it to generate robot code. For example, robot code generation engine 94 may query flow block dataset 930 about how many kinds of workpieces (e.g., how many workpiece islands in user interface 2) need to be processed by a specific robot, e.g., Robot A (i.e., the workforce), and how many processes should be done on a specific workpiece (i.e., flow blocks in the process flow on a workpiece island), for example, “Workpiece A comes from Tray A, should be placed to Tray B,” which might be established with a process flow of Workpiece A with a “SOURCE” flow block assigned with Tray A, and a “PLACE” flow block with Tray B, while Robot A is assigned to “PLACE” flow block. During the query, the robot code generation engine may obtain necessary position data from the virtual object dataset 910 through flow block dataset 930, a preferred implementation with a simpler program interface. For example, according to “Workpiece A comes from Tray A,” and “should be placed to Tray B,” the program in robot code generation engine 94 may parse and find there is a “PLACE” block after the “SOURCE” block, by the data “Flow_block_id,” “Following_block_id,” and “Type” in the flow block dataset 904, which can indicate to a conclusion that the Robot A should grip Workpiece A first because it needs to be placed to Tray B. In this case, robot code generation engine 94 may generate a robot code to grip Workpiece A from Tray A. In this generated action and motion, robot code generation engine 94 may query the positional information of Workpiece A, default in the slot 1-1 of the sixth layer of Tray A, in which each layer has a thickness of 10 mm. Tray A is located at the coordinate {100.0,200.0,300.0,90.0,0.0,180.0} to the world coordinate (e.g., “Base_id” is zero). The position of the desired workpiece to grip can be obtained by implementing mathematical calculation. Then, the robot codes (i.e., the robot program and/or a virtual agent program) with action and motion similar to examples shown in FIG. 1 can be generated.

After a robot code is generated, it may be transmitted to a robot code execution engine 96, which is usually a physical or a simulated robot controller for execution. The generated robot code may transmit a request to virtual object dataset 910 to update the index “Current_tray_slots_X” and “Current_tray_slots_Y”. Robot code generation engine 94 may generate a robot code to check when “Current_tray_slots_X” and “Current_tray_slots_Y” exceed the data “Slots_in_X” and “Slots_in_Y” and generate a robot code to remove the emptied layer of Tray A and put it to an empty tray stack. If desired, Robot code generation engine 94 may generate all the program lines with variables before the project is executed, and robot code execution engine 96 may update the variables according to the latest updated indexes of the virtual object when the project is executing. This has the advantage of preventing the generating of robot code online, which may cause the robot to stop its motion or consume more computing power (e.g., a parallel program to generate that online robot code to prevent the robot stops). Robot code execution engine 96 may drive one or more physical robots 99 and/or one or more simulated robots in the digital twin engine 98. The updated indexes of virtual objects may be transmitted to the digital twin engine 98 to update the visualization of the virtual objects; for example, animations of the workpiece [1-1] are moved to another tray, or an emptied tray is moved to an empty tray stack. Digital twin engine 98 may maintain and update an obstacle model of the work cell by calculating the latest position of each virtual object with their dimension (e.g., dimension in X, Y, and Z, to form a bounding box) as an input of a collision-free path planning function of the robot's controller.

The above software architecture may not only be implemented in a graphical process flow, like those shown in FIGS. 3,5,9,12, but also the text-type process flow shown in FIG. 13, because the software architecture is the mechanism working under a user interface and is the way to describe or define a virtual work cell, while the text-type and graphical process flow are just utilizing different methods in the interfaces between the user and a robotics system, that both the disclosed graphical process flow and the text-based process flow belong to the workpiece-based process flow or workpiece-based programming methods, and are not belong to robot-code-based programming.

If desired, the user interface may also include functions and interfaces for manipulating a physical robot or a simulated robot to set a desired cartesian pose or joint positions, e.g., jogging the robot, or set a desired motion and motion parameters for a pose, e.g., LINE, or PTP, the linear speed, joint speed, the cartesian linear acceleration, the joint acceleration . . . etc. Furthermore, the user interface may also include functions and interfaces to set the actions and/or parameters of a physical or a simulated robot, e.g., HIGH/LOW of a digital I/O, delay time between actions or motions, safety parameters like the motion range of a joint, a cartesian space motion limitation, speed limitation in the cartesian or joint space, parameters for setting the field bus connection between the robot and other equipment in the automation cell, and so on.

In order to better manage the work of the users in the same user interface, if desired, a user interface may include a function and interface to establish and manage the user accounts, especially when the user interface is provided from the cloud server for multiple users to use at the same time. A user interface may include a function to set working groups for the users to manage the accessibility of different projects and a function to log in and log out for different kinds of users of different function accessibility, e.g., automation cell designers, robot's original providers, and factory workers. To better evaluate the design of an automation cell, a user interface may provide a function to allow more than one user to access the same projects at the same time, and the users can modify one or more parameters of the project at the same time, in an on-line meeting through the Internet. As such, a user interface may have each other's cursor display in the interface for a better understanding of each other's operations on the user interface, e.g., pan/tilt/zoom of the view of the 3D cell space or a virtual object, pointing out a specific point or a virtual object in the cell space, choosing, moving, or configuring one or more flow block in the process flow. If desired, the user interface may include a function of online communication, e.g., text dialogues or a vocal or video conference, with which users can exchange ideas in real time when looking at the same process flow or cell space.

To better visualize the virtual objects or the workpiece, a user interface may include a function or interface to import a CAD file of them. In a simpler example, the imported CAD model may be placed in a specific position of the model of the virtual object, while the virtual object is defined with a simpler shape, e.g., a box, which may already satisfy the needs to set up the process flow or the work cell, and the imported CAD model only shows the detail shapes for the visualization purpose in a six degree of freedom motion or manipulation. In an advanced example, a user interface may include a function to recognize or extract one or more geometrical or mechanical features of the imported CAD model, e.g., a point, an edge, a plane, a chamfer, a hole, a curved edge or surface, a screw hole with thread, and so on, and transform them into parameters for the functions in the user interface, e.g., reconfiguring one or more of features like reducing the thickness or moving a screw hole feature, assigning a position or a pose according to one or more features, attaching a coordinate system to one or more features, snaping one or more features in an assembling application, assigning the motion of a polishing or deburring application according to a curved surface or a curved edge. The extraction and transformation of the geometrical or mechanical features may be implemented by analyzing a BREP (Boundary Representation) format of the CAD file, extracting the described points, edges, and planes in the format, or extracting or generating a NURBS (Non-Uniform Rational B-splines) format of the description of the curved edge or curved surface. These advanced functions may reduce the efforts of establishing or setting the virtual objects or workpieces of more complex geometrical features.

What is claimed is:

1. A robotic system, comprising:
one or more processors, configured to communicate with a physical robot and to control the motion of the physical robot according to a robot program; and
a user interface, comprising:
one or more configuration interfaces, configured to set one or more virtual objects which at least comprise one or more virtual workpieces and to set an initial positional relationship between at least one of the one or more virtual objects and a virtual robot which corresponds to the physical robot, wherein the one or more virtual objects comprise one or more configurable specifications; and
a process flow interface, for configuring one or more processes for the one or more virtual workpieces, wherein the one or more processes comprise one or more process flow units which display an icon and/or text for one or more users to set the one or more processes with one or more process parameters and the one or more processes are connectable to each other to form at least one process flow, wherein at least one of the one or more process parameters set the change of the relative position between the one or more virtual workpieces and at least one of the one or more virtual objects and one or more virtual tools.

2. The robotic system according to claim 1, wherein the robotic system comprises the physical robot that has a tool end which is configured to couple with the one or more physical tools which corresponds to the one or more virtual tools to process one or more physical workpieces which corresponds to the one or more virtual workpieces.

3. The robotic system according to claim 1, wherein the one or more processors comprise a program generating module that generates the robot program and/or a virtual agent program according to the at least one process flow, the one or more process parameters and the one or more configurable specifications of the one or more virtual objects, wherein the virtual agent program is used for one or more virtual agents which at least comprise the virtual robot.

4. The robotic system according to claim 1, the one or more configurable specifications of the one or more virtual objects comprise a dimension of one of the geometric features of the one or more virtual objects.

5. The robotic system according to claim 1, the one or more configuration interfaces are configured to set one or more default positional relationship between one of the one or more virtual tools and one of the one or more virtual objects for gripping the one or more virtual objects, or to initialize a manufacturing process to the one or more virtual workpieces.

6. The robotic system according to claim 1, the one or more configurable specifications of the one or more virtual objects comprise one or more positions of the one or more virtual objects for carrying the one or more workpieces.

7. The robotic system according to claim 6, the one or more configurable specifications of the one or more virtual objects further comprise a working specification describing an information on loading or unloading the one or more virtual workpieces into the one or more positions of the one or more virtual objects for carrying the one or more workpieces which comprise one or more relative positions and one or more vectors, or one or more distances to set with one or more directions to the one or more positions of the one or more virtual objects for carrying the one or more virtual workpieces.

8. The robotic system according to claim 1, the one or more process flow units are further configured to generate a new virtual workpiece in the process flow from combining two or more existing virtual workpieces with a setting which at least describes the positional relationship between the two or more existing virtual workpieces.

9. The robotic system according to claim 1, the one or more process flow units are further configured to generate a new virtual workpiece in the process flow from an existing virtual workpiece, after the one or more processes are changed or added, with at least a specification of the new virtual workpiece representing a manufacturing process meaning other than a change of position.

10. The robotic system according to claim 1, the user interface further comprises a display interface that is configured to display the change of the position of the one or more virtual workpieces, the one or more virtual objects, and/or the one or more tools, in a sequence according to the process flow.

11. The robotic system according to claim 10, the display interface is further configured to display the motion of the virtual robot according to the process flow.

12. The robotic system according to claim 1, the user interface further comprises a function to generate a CAD file or a drawing according to the one or more virtual objects.

13. The robotic system according to claim 1, the virtual agent further comprises a virtual human worker and a virtual human position of the virtual human worker related to the virtual robot.

14. The robotic system according to claim 1, the one or more processors comprise a program generating module that is located in a cloud server.

15. The robotic system according to claim 1, the one or more processors comprise a program generating module that is located in a controller of the physical robot.

16. A method for programming a physical robot, the method comprising:
setting one or more virtual objects which at least comprise one or more virtual workpieces, wherein the one or more virtual objects comprise one or more configurable specifications and a coordinate;
setting one or more initial positions of the one or more virtual workpieces;
setting an initial positional relationship between at least one of the one or more virtual objects and a virtual robot which corresponds to the physical robot;
setting one or more processes for the one or more virtual workpieces, wherein the one or more processes comprise one or more process parameters to set the change of the relative position between one of the one or more virtual workpieces and at least one chosen from the one or more virtual objects, the virtual robot, a world coordinate, and/or one or more virtual tools, wherein the one or more processes for the one or more virtual workpieces are set according to a sequential relationship of the desired process of the one or more virtual workpieces; and
generating a robot program according to the one or more processes, the one or more process parameters and the one or more configurable specifications of the one or more virtual objects.

17. The method according to claim 16, the one or more processes for the one or more virtual workpieces are set through two or more icons which are connectable to each other to form at least one process flow.

18. The method according to claim 16, the one or more processes for the one or more virtual workpieces are set through a group of text describing the one or more processes for the one or more virtual workpieces and are capable to be arranged according to an order between at least two of the one or more processes for the one or more virtual workpieces.

19. The method according to claim 16, the one or more processes for the one or more virtual workpieces are set through one or more text describing the one or more processes for the one or more virtual workpieces and one or more icons which are connectable to each other to form at least one linear process flow.

20. The method according to claim 16, the one or more initial positions of the one or more virtual workpieces are set to be coupled with at least one of the one or more virtual objects which is a virtual container.
